(19) United States
(12) Patent Application Publication
(10) Pub. No.: US 2015/0037030 A1
(43) Pub. Date: Feb. 5, 2015

(54) Optical Switching Devices Including Phase Transition Materials

(71) Applicant: Samsung Electronics Co., Ltd., Suwon-si (KR)

(72) Inventors: Choong-Rae Cho, Suwon-si (KR); Young-Sub You, Osan-si (KR)

(73) Assignee: Samsung Electronics Co., Ltd., Suwon-si (KR)

(21) Appl. No.: 14/259,713

(22) Filed: Apr. 23, 2014

(30) Foreign Application Priority Data
Aug. 2, 2013 (KR) 10-2013-0092073

(51) Int. Cl. H04Q 11/00

(52) U.S. Cl. CPC H04Q 11/0005; H04Q 2011/0032; H04Q 2011/0035
USPC 398/48

(57) ABSTRACT

An optical switching device includes a substrate having an optical waveguide thereon, and a phase transition pattern in or on a portion of the optical waveguide. The phase transition pattern includes a material that is configured to be switched between insulating and conductive states responsive to a stimulus. At least one conductive element on the substrate directly contacts the phase transition pattern to provide the stimulus to the phase transition pattern. Related fabrication methods are also discussed.

### CROSS-REFERENCE TO RELATED APPLICATION

This application claims priority under 35 U.S.C. §119 to Korean Patent Application No. 10-2013-0092073 filed on Aug. 2, 2013, the disclosure of which is hereby incorporated by reference in its entirety.

### BACKGROUND

1. Field

Embodiments of the inventive concept relate to optical switching devices and methods of fabricating the same.

2. Description of Related Art

Optical switching devices are devices that receive/transmit data using light. An optical switching device may receive/transmit data by turning on/off light within a waveguide that transmits an optical signal. Various proposals and research on high-speed optical switching devices and methods of fabricating the same are progressing.

### SUMMARY

Embodiments of the inventive concept provide optical switching devices having a phase transition pattern.

Embodiments of the inventive concept also provide methods of fabricating an optical switching device having a phase transition pattern.

Embodiments of the inventive concept also provide semiconductor modules and electronic systems that include an optical switching device having a phase transition pattern.

The technical objectives of the inventive concept are not limited to the disclosure herein; other objectives may become apparent to those of ordinary skill in the art based on the following descriptions.

According to some aspects of the inventive concept, an optical switching device includes a substrate having an optical waveguide, and a phase transition pattern within or on a portion of the optical waveguide. The phase transition pattern includes a material that is configured to be switched between insulating and conductive states responsive to a stimulus. At least one conductive element on the substrate directly contacts the phase transition pattern. The conductive element is configured to provide the stimulus to the phase transition pattern.

In some embodiments, the conductive element may be confined outside of the optical waveguide and extends at least partially along a sidewall thereof. For example, the conductive element may be first and second slabs adjacent respective sidewalls of the optical waveguide.

In some embodiments, the first and second slabs may include a same material as the optical waveguide. For example, the optical waveguide may be formed of silicon, the first and second slabs may be formed of doped silicon. The first and second slabs may have respective thicknesses less than those of the optical waveguide and/or the phase transition pattern.

In some embodiments, a conductive lower electrode may extend within the optical waveguide between the phase transition pattern and the substrate. A conductive upper electrode may extend on the phase transition pattern opposite the lower electrode. The lower electrode and the first and second slabs may be formed of silicon doped with an n-type or p-type impurity.

In some embodiments, the phase transition pattern may be confined within the optical waveguide. In other embodiments, the phase transition pattern may be on one or more external surfaces of the optical waveguide.

In accordance with an aspect of the inventive concept, an optical switching device includes a substrate including a trench, a lower cladding layer including an insulating material filled in the trench, an optical waveguide formed on the lower cladding layer, a phase transition pattern buried within a part of the optical waveguide to have the same thickness as a thickness of the optical waveguide, first and second slabs formed at both sides of the phase transition pattern and electrically connected to the phase transition pattern, and an upper cladding layer formed on the substrate and the lower cladding layer so as to cover the optical waveguide, the phase transition pattern, and the first and second slabs.

In some embodiments, the phase transition pattern may include a vanadium oxide.

In another embodiment, each of the first and second slabs may have a thickness that is less than a thickness of the phase transition pattern.

In still another embodiment, the first and second slabs may be vertically disposed at the same level.

In yet another embodiment, the first and second slabs may be vertically disposed at different levels.

In yet another embodiment, the optical switching device may further include first and second slab via plugs directly contacting the first and second slabs by vertically penetrating the upper cladding layer, and first and second slab pads formed on the upper cladding layer so as to cover upper parts of the first and second slab via plugs.

In accordance with another aspect of the inventive concept, an optical switching device includes: a substrate including a trench; a lower cladding layer including an insulating material filled in the trench; an optical waveguide formed on the lower cladding layer; a lower electrode region being in a part of the optical waveguide to have the same thickness as a thickness of the optical waveguide; first and second slabs formed at both sides of the phase transition pattern to a thickness that is less than a thickness of the lower electrode region; a phase transition pattern formed on the lower electrode region and parts of the first and second slabs; an upper electrode formed on a part of the phase transition pattern; and an upper cladding layer formed on the substrate and the lower cladding layer so as to cover the optical waveguide, the first and second slabs, the phase transition pattern, and the upper electrode.

In some embodiments, the optical switching device may further include: a slab via plug directly contacting either of the first and second slabs by vertically penetrating the upper cladding layer; an upper electrode via plug directly contacting the upper electrode by vertically penetrating the upper cladding layer; a slab pad formed on the upper cladding layer so as to cover an upper part of the slab via plug; and an upper electrode pad formed on the upper cladding layer so as to cover an upper part of the upper electrode.

In another embodiment, the upper electrode may include: a first upper electrode formed on parts of top and side surfaces of the phase transition pattern; and a second upper electrode spaced apart from the first upper electrode by a gap and formed on other parts of the top and side surfaces of the phase transition pattern.

In still another embodiment, the optical switching device may further include an intermediate cladding layer formed on the substrate and the lower cladding layer, surrounding a part of both sides of the optical waveguide, and inserted between the lower cladding layer and the upper cladding layer.

Detailed matters of other embodiments are included in the detailed description and the drawings.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating principles of the inventive concepts. In the drawings:

FIG. 1A is a partial perspective view schematically illustrating an optical switching device in accordance with some embodiments of the inventive concept, and FIG. 1B is a longitudinal cross-sectional view taken along line I-I′ illustrated in FIG. 1A;

FIG. 2A is a partial perspective view schematically illustrating an optical switching device in accordance with some embodiments of the inventive concept, and FIG. 2B is a longitudinal cross-sectional view taken along line I-I′ illustrated in FIG. 2A;

FIG. 3A is a partial perspective view schematically illustrating an optical switching device in accordance with some embodiments of the inventive concept, and FIG. 3B is a longitudinal cross-sectional view taken along line I-I′ illustrated in FIG. 3A;

FIG. 4A is a partial perspective view schematically illustrating an optical switching device in accordance with some embodiments of the inventive concept, and FIG. 4B is a longitudinal cross-sectional view taken along line I-I′ illustrated in FIG. 4A;

FIG. 5A is a partial perspective view schematically illustrating an optical switching device in accordance with some embodiments of the inventive concept, and FIG. 5B is a longitudinal cross-sectional view taken along line I-I′ illustrated in FIG. 5A;

FIGS. 6A through 6U illustrate operations of a method of fabricating an optical switching device in accordance with some embodiments of the inventive concept and are longitudinal cross-sectional views taken along line I-I′ of FIG. 1A;

FIGS. 7A through 7O illustrate operations of a method of fabricating an optical switching device in accordance with some embodiments of the inventive concept and are longitudinal cross-sectional views taken along line I-I′ of FIG. 3A;

FIGS. 8A through 8F illustrate operations of a method of fabricating an optical switching device in accordance with some embodiments of the inventive concept and are longitudinal cross-sectional views taken along line I-I′ of FIG. 4A;

FIG. 9 is a view of construction of a memory device including an optical switching device in accordance with some embodiments of the inventive concept;

FIG. 10 is a view of construction of a semiconductor module including an optical switching device in accordance with some embodiments of the inventive concept; and

FIG. 11 is a view of construction of an electronic device including an optical switching device in accordance with some embodiments of the inventive concept.

### DETAILED DESCRIPTION OF THE EMBODIMENTS

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art. In the drawings, the sizes and relative sizes of layers and regions may be exaggerated for clarity.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present inventive concept. In addition, as used herein, the singular forms “a”, “an” and “the” are intended to include the plural forms as well, unless the context clearly indicates otherwise. It also will be understood that, as used herein, the term “comprising” or “comprises” is open-ended, and includes one or more stated elements, steps and/or functions without precluding one or more unstated elements, steps and/or functions. The term “and/or” includes any and all combinations of one or more of the associated listed items.

It will also be understood that when an element is referred to as being “connected” to another element, it can be directly connected to the other element or intervening elements may be present. In contrast, when an element is referred to as being “directly connected” to another element, there are no intervening elements present. It will also be understood that the sizes and relative orientations of the illustrated elements are not shown to scale, and in some instances they have been exaggerated for purposes of explanation.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

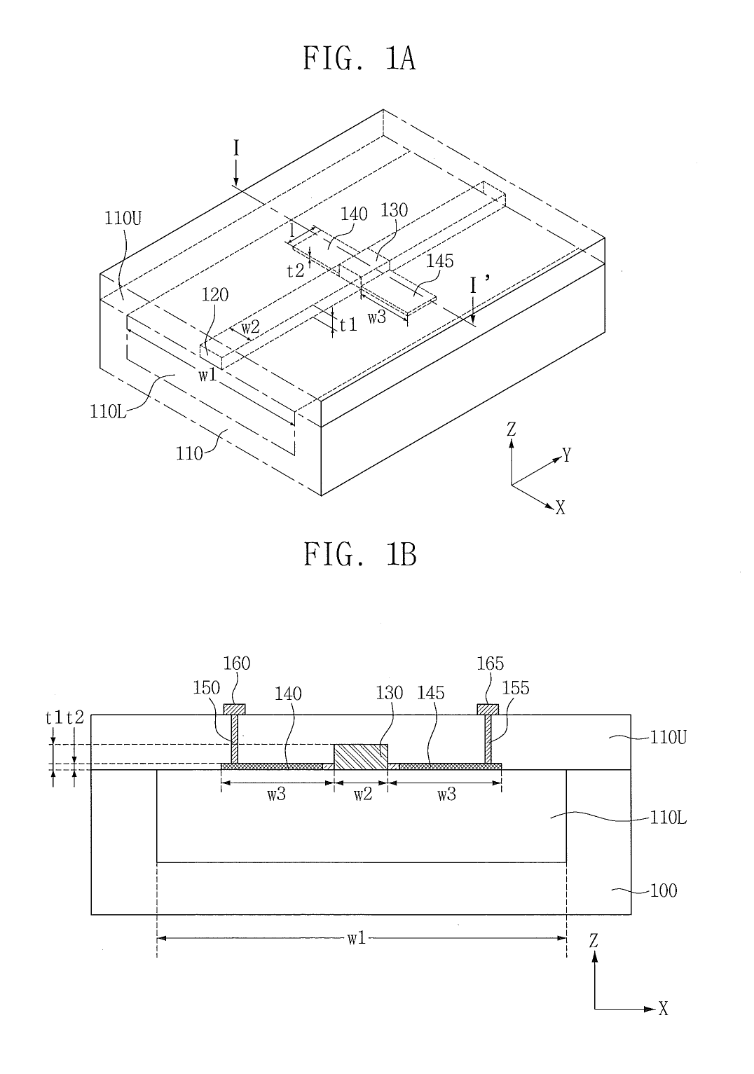

FIG. 1A is a partial perspective view schematically illustrating an optical switching device in accordance with some embodiments of the inventive concept, and FIG. 1B is a longitudinal cross-sectional view taken along line I-I′ illustrated in FIG. 1A.

Referring to FIGS. 1A and 1B, the optical switching device in accordance with the embodiment of the inventive concept may include a substrate 100, a lower cladding layer 110L, an optical waveguide 120, a phase transition pattern 130, first and second slabs 140 and 145, and an upper cladding layer 110U. The optical switching device in accordance with the embodiment of the inventive concept may further include first and second slab via plugs 150 and 155 and first and second slab pads 160 and 165.

The substrate 100 may be a bulk silicon wafer. The substrate 100 may include monocrystalline silicon.

The lower cladding layer 110L may be buried within the substrate 100. The lower cladding layer 110L may have a first horizontal width w1 in a first direction X and may extend in a second direction Y perpendicular to the first direction X. The lower cladding layer 110L may include a silicon oxide. The lower cladding layer 110L may have a lower refractive index than a refractive index of the optical waveguide 120 that will be described below.

The optical waveguide 120 may be a transmission line that transmits an optical signal. The optical waveguide 120 may optically connect a coupler and a photoelectric converter. The optical waveguide 120 may be disposed on the lower cladding layer 110L and may have a second horizontal width w2 that is less than the first horizontal width w1 in the first direction X. The optical waveguide 120 may have a first thickness t1 in a third direction Z perpendicular to planes formed in the first direction X and the second direction Y. The optical waveguide 120 may include monocrystalline silicon. The optical waveguide 120 may have a higher refractive index than the refractive index of the lower cladding layer 110L and a refractive index of the upper cladding layer 110U that will be described below.

The phase transition pattern 130 may be buried or confined within the optical waveguide 120. A horizontal width and a thickness of the phase transition pattern 130 are the same as or similar to those of the optical waveguide 120. That is, the phase transition pattern 130 may have the second horizontal width w2 in the first direction X and may have the first thickness t1 in the third direction Z. The phase transition pattern 130 may have a length 1 in the second direction Y. The phase transition pattern 130 may be transformed into a metallic or conducting state from an insulating or non-conducting state and vice versa depending on the amount of a carrier injected into the phase transition pattern 130 due to a voltage or other stimulus applied to the phase transition pattern 130. For example, when no voltage is applied to the phase transition pattern 130, the phase transition pattern 130 may be in the insulating state, and when a voltage is applied to the phase transition pattern 130, the phase transition pattern 130 may be in the metallic state. When the phase transition pattern 130 is in the insulating state, light that is being transmitted through the optical waveguide 120 may pass through the phase transition pattern 130 at an optical transmittance of about 90 to about 95%; that is, the phase transition pattern may be substantially transparent in the insulating state. On the other hand, when the phase transition pattern 130 is in the metallic state, light that is being transmitted through the optical waveguide 120 may be absorbed, scattered, and/or reflected by the injected carrier and may pass through the phase transition pattern 130 at an optical transmittance of about 5 to about 10%. Thus, the phase transition pattern 130 may operate as a switch that turns on/off (that is, allows or prevents passage of) light transmitted through the optical waveguide 120 due to a rapid change in optical transmittance depending on the insulating state and/or metallic state. For example, when the phase transition pattern 130 is in the insulating state, the phase transition pattern 130 may operate to turn on the light transmission, and when the phase transition pattern 130 is in the metallic state, the phase transition pattern 130 may operate to turn off the light transmission. The phase transition pattern 130 may include a vanadium oxide.

The first and second slabs 140 and 145 may be formed at both sides of the phase transition pattern 130, and in some embodiments, may be confined outside of the waveguide 120. Each of the first and second slabs 140 and 145 may have a third horizontal width w3 that is less than the first horizontal width w1 and greater than the second horizontal width w2 in the first direction X (w1>w3>w2) and may have a second thickness t2 that is less than or equal to the first thickness t1 in the third direction Z (t1≧t2). Each of the first and second slabs 140 and 145 may have the same length as the length 1 of the phase transition pattern 130 in the second direction Y. Each of the first and second slabs 140 and 145 may be also formed in any position of both sides of the phase transition pattern 130 in the third direction Z. For example, the first and second slabs 140 and 145 may be formed in such a way that bottom surfaces of the first and second slabs 140 and 145 may be placed on the same horizontal plane as a bottom surface of the phase transition pattern 130, as illustrated in FIGS. 1A and 1B. In this case, good horizontal uniformity of injecting the carrier into the phase transition pattern 130 may be obtained. The first and second slabs 140 and 145 may be electrically connected to the phase transition pattern 130. Each of the first and second slabs 140 and 145 may include doped silicon. Each of the first and second slabs 140 and 145 may include a P-type impurity and/or an N-type impurity. As such, the first and second slabs 140 and 145 may be conductive elements configured to apply a voltage or other stimulus to the phase transition pattern 130 to change the phase thereof.

The upper cladding layer 110U may be formed on the substrate 100, the lower cladding layer 110L, the optical waveguide 120, the phase transition pattern 130, and the first and second slabs 140 and 145 so as to have a thickness. The upper cladding layer 110U may include a silicon oxide. The upper cladding layer 110U and the lower cladding layer 110L may include the same material so as to be materially connected to each other. The upper cladding layer 110U may have a lower refractive index than the refractive index of the optical waveguide 120.

In the present embodiment, the optical waveguide 120, the phase transition pattern 130, and the first and second slabs 140 and 145 may be embedded or encapsulated by the lower cladding layer 110L and the upper cladding layer 110U.

The first and second slab via plugs 150 and 155 may penetrate the upper cladding layer 110U vertically and may directly contact the first and second slabs 140 and 145 so as to be electrically connected to the first and second slabs 140 and 145. Each of the first and second slab via plugs 150 and 155 may include a metal or metal compound. Outer sides of the first and second slab via plugs 150 and 155 may be surrounded by the upper cladding layer 110U formed of an insulating material.

The first and second slab pads 160 and 165 may be formed on the upper cladding layer 110U so as to contact and/or cover upper parts of the first and second slab via plugs 150 and 155. The first and second slab pads 160 and 165 may include a metal or metal compound.

In the optical switching device according to the present embodiment, when a voltage is applied to the optical switching device via the first and second slab pads 160 and 165, the voltage may be applied to both left and right ends of the phase transition pattern 130 through the first and second slabs 140 and 145 via the first and second slab via plugs 150 and 155. The amount of the carrier injected into the phase transition pattern 130 may be adjusted depending on a magnitude of the applied voltage. Thus, in the optical switching device according to the present embodiment, the phase transition pattern 130 is transformed into the metallic state from the insulating state or vice versa depending on the amount of the injected carrier, thereby turning on/off light transmitted through the optical waveguide 120.

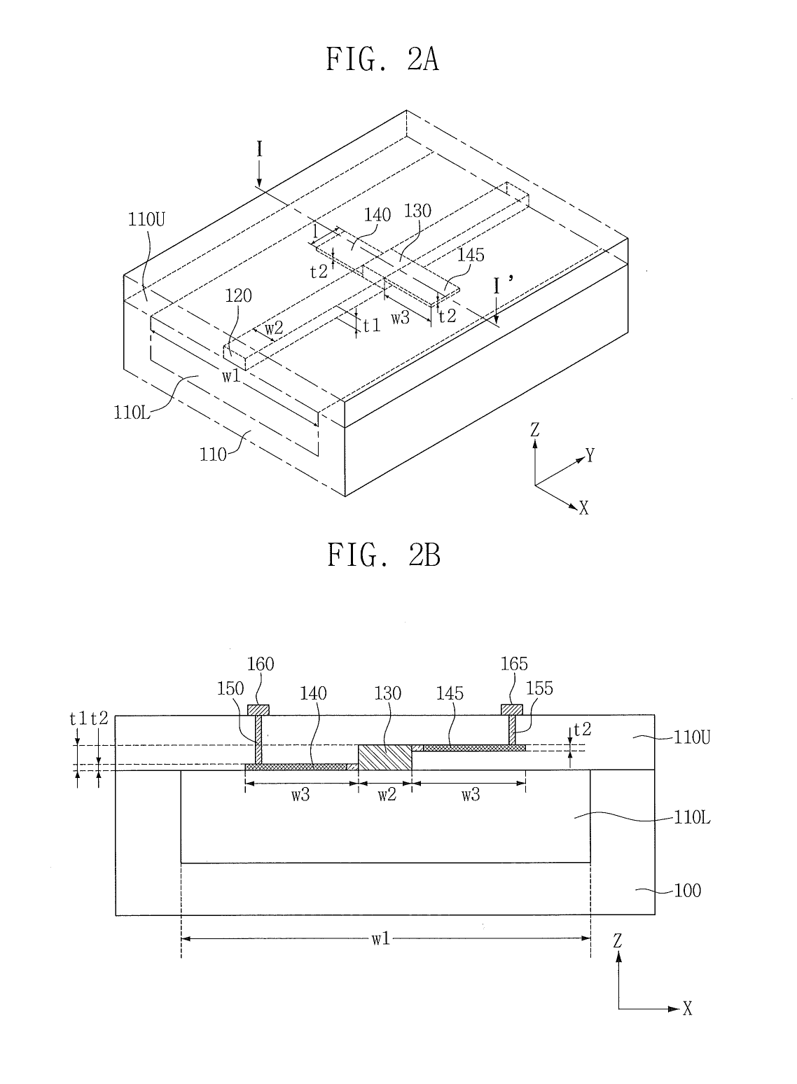

FIG. 2A is a partial perspective view schematically illustrating an optical switching device in accordance with some embodiments of the inventive concept, and FIG. 2B is a longitudinal cross-sectional view taken along line I-I′ illustrated in FIG. 2A. The optical switching device illustrated in FIGS. 2A and 2B is similar to the optical switching device illustrated in FIGS. 1A and 1B except the position of a second slab 145. Thus, detailed descriptions of the same elements will be omitted.

Referring to FIGS. 2A and 2B, the optical switching device in accordance with some embodiments of the inventive concept may include a substrate 100, a lower cladding layer 110L, an optical waveguide 120, a phase transition pattern 130, first and second slabs 14Q and 145, and an upper cladding layer 110U. The optical switching device in accordance with some embodiments of the inventive concept may further include first and second slab via plugs 150 and 155 and first and second slab pads 160 and 165.

In the present embodiment, the first slab 140 may be formed in such a way that a bottom surface of the first slab 140 may be placed on the same horizontal plane as a bottom surface of the phase transition pattern 130, and the second slab 145 may be formed in such a way that a top surface of the second slab 145 may be placed on the same horizontal plane as a top surface of the phase transition pattern 130. In this case, good vertical uniformity of injecting the carrier into the phase transition pattern 130 may be obtained.

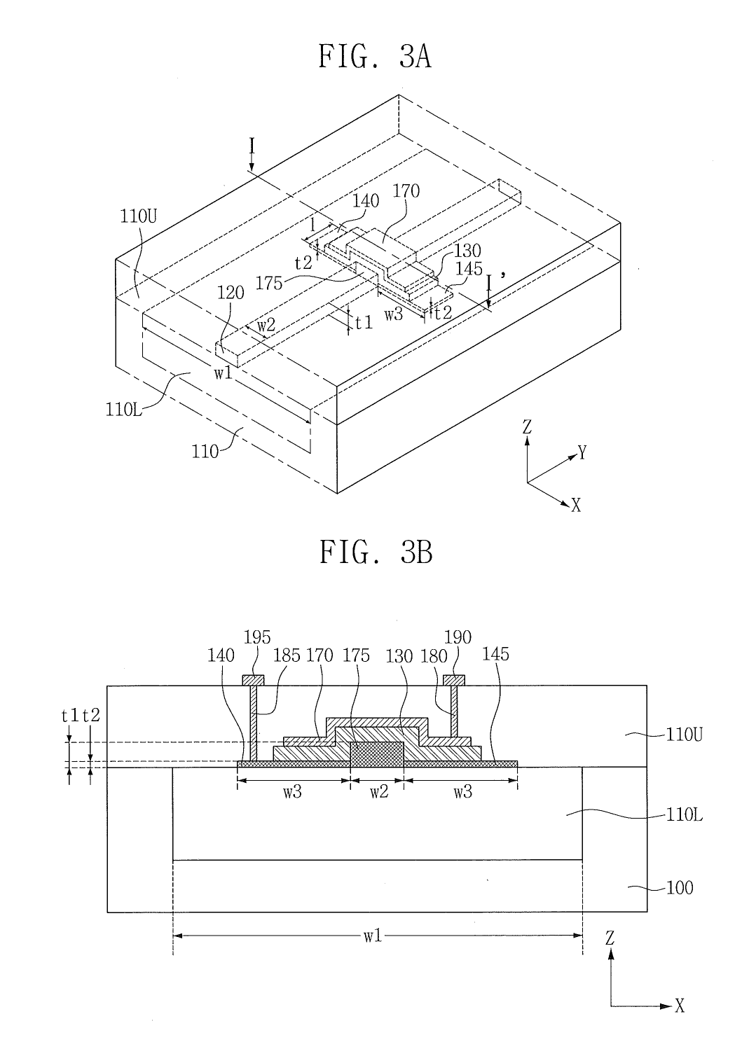

FIG. 3A is a partial perspective view schematically illustrating an optical switching device in accordance with some embodiments of the inventive concept, and FIG. 3B is a longitudinal cross-sectional view taken along line I-I′ illustrated in FIG. 3A.

Referring to FIGS. 3A and 3B, the optical switching device in accordance with some embodiments of the inventive concept may include a substrate 100, a lower cladding layer 110L, an optical waveguide 120, a lower electrode region 175, first and second slabs 140 and 145, a phase transition pattern 130, an upper electrode 170, and an upper cladding layer 110U. The optical switching device in accordance with some embodiments of the inventive concept may further include an upper electrode via plug 180, a lower electrode via plug 185, an upper electrode pad 190, and a lower electrode pad 195.

The substrate 100 may be a bulk silicon wafer. The substrate 100 may include monocrystalline silicon.

The lower cladding layer 110L may be buried within the substrate 100. The lower cladding layer 110L may have a first horizontal width w1 in a first direction X and may extend in a second direction Y perpendicular to the first direction X. The lower cladding layer 110L may include a silicon oxide. The lower cladding layer 110L may also have a lower refractive index than a refractive index of the optical waveguide 120 that will be described below.

The optical waveguide 120 may be a transmission line that transmits an optical signal. The optical waveguide 120 may optically connect a coupler and a photoelectric converter. The optical waveguide 120 may be disposed on the lower cladding layer 110L and may have a second horizontal width w2 that is less than the first horizontal width w1 in the first direction X. The optical waveguide 120 may have a first thickness t1 in a third direction Z perpendicular to a plane formed in the first direction X and the second direction Y. The optical waveguide 120 may include monocrystalline silicon. The optical waveguide 120 may have a higher refractive index than the refractive index of the lower cladding layer 110L and a refractive index of the upper cladding layer 110U that will be described below.

The lower electrode region 175 may be formed to be buried or confined within a part of the optical waveguide 120. A horizontal width and a thickness of the lower electrode region 175 are similar to those of the optical waveguide 120. That is, the lower electrode region 175 may have the second horizontal width w2 in the first direction X and the first thickness t1 in the third direction Z. The lower electrode region 175 may have a length 1 in the second direction Y. The lower electrode region 175 may be electrically connected to the phase transition pattern 130 that will be described below. The lower electrode region 175 may include doped silicon. The lower electrode region 175 may include a P-type impurity and/or an N-type impurity.

The first and second slabs 140 and 145 may be formed at both sides of the lower electrode region 175. Each of the first and second slabs 140 and 145 may have a third horizontal width w3 that is less than the first horizontal width w1 and greater than the second horizontal width w2 in the first direction X (w1>w3>w2) and may have a second thickness t2 that is less than or equal to the first thickness t1 in the third direction Z (t1≧t2). Each of the first and second slabs 140 and 145 may have the same length as the length 1 of the lower electrode region 175 in the second direction Y. Each of the first and second slabs 140 and 145 may be also formed in any position at both sides of the lower electrode region 175 in the third direction Z. For example, the first and second slabs 140 and 145 may be formed in such a way that bottom surfaces of the first and second slabs 140 and 145 may be placed on the same horizontal plane as a bottom surface of the lower electrode region 175, as illustrated in FIGS. 3A and 3B. Each of the first and second slabs 140 and 145 may include the same material so as to be materially connected to the lower electrode region 175. Each of the first and second slabs 140 and 145 may be electrically connected to the phase transition pattern 130 that will be described below. Each of the first and second slabs 140 and 145 may include doped silicon. Each of the first and second slabs 140 and 145 may include a P-type impurity and/or an N-type impurity, thereby defining conductive elements that are configured to apply a voltage or other stimulus to the phase transition pattern 130 to change the phase thereof.

The phase transition pattern 130 may be formed partially or entirely on surfaces of the first and second slabs 140 and 145 and a surface of the lower electrode region 175. In detail, the phase transition pattern 130 may be formed to surround parts of top surfaces of the first and second slabs 140 and 145 and parts of sides and a top surface of the lower electrode region 175. The phase transition pattern 130 may have a horizontal width that is less than the first horizontal width w1 and greater than the second horizontal width w2 in the first direction X and may have a thickness in the third direction Z. The phase transition pattern 130 may have the same length as the length 1 of the lower electrode region 175 in the second direction Y. The phase transition pattern 130 may be transformed into a metallic state from an insulating state or vice versa depending on the amount of a carrier injected into the phase transition pattern 130 due to a voltage applied to the phase transition pattern 130. For example, when no voltage is applied to the phase transition pattern 130, the phase transition pattern 130 may be in the insulating state, and when a voltage is applied to the phase transition pattern 130, the phase transition pattern 130 may be in the metallic state. When the phase transition pattern 130 is in the insulating state, light that is being transmitted through the optical waveguide 120 may pass through the phase transition pattern 130 at an optical transmittance of about 90 to about 95%. On the other hand, when the phase transition pattern 130 is in the metallic state, light that is being transmitted through the optical waveguide 120 may be absorbed, scattered, and/or reflected by the injected carrier and may pass through the phase transition pattern 130 at an optical transmittance of about 5 to about 10%. Thus, the phase transition pattern 130 may operate as a switch that turns on/off (that is, allows or prevents passage of) light transmitted through the optical waveguide 120 due to a rapid change in optical transmittance depending on the insulating state and/or metallic state. For example, when the phase transition pattern 130 is in the insulating state, the phase transition pattern 130 may operate to turn on the light transmission, and when the phase transition pattern 130 is in the metallic state, the phase transition pattern 130 may operate to turn off the light transmission. The phase transition pattern 130 may include a vanadium oxide.

The upper electrode 170 may be formed partially or entirely on a part of a top surface of the phase transition pattern 130. In this case, the upper electrode 170 may be formed to cover all of a top surface of the phase transition pattern 130 vertically aligned with the lower electrode region 175 or to cover only a part of the top surface of the phase transition pattern 130 vertically aligned with the first and second slabs 140 and 145. The upper electrode 170 may have a horizontal width that is less than the horizontal width of the phase transition pattern 130 in the first direction X and may have a thickness in the third direction Z. The upper electrode 170 may have the same length as the length 1 of the phase transition pattern 130 in the second direction Y. The upper electrode 170 may be electrically connected to the phase transition pattern 130. The upper electrode 170 may include a metal or metal compound. The upper electrode may include a transparent electrode, for example, an indium tin oxide (ITO).

The upper cladding layer 110U may be formed on the substrate 100, the lower cladding layer 110L, the optical waveguide 120, the first and second slabs 140 and 145, the phase transition pattern 130, and the upper electrode 170 so as to have a thickness. The upper cladding layer 110U may include a silicon oxide. The upper cladding layer 110U and the lower cladding layer 110L may include the same material so as to be materially connected to each other. The upper cladding layer 110U may have a lower refractive index than the refractive index of the optical waveguide 120.

In the present embodiment, the optical waveguide 120, the first and second slabs 140 and 145, the lower electrode region 175, the phase transition pattern 130, and the upper electrode 170 may be embedded or encapsulated by the lower cladding layer 110L and the upper cladding layer 110U.

The upper electrode via plug 180 may penetrate the upper cladding layer 110U vertically and may directly contact the upper electrode 170 so as to be electrically connected to the upper electrode 170. The upper electrode via plug 180 may include a metal or metal compound. Sides of the upper electrode via plug 180 may be surrounded by the upper cladding layer 110U formed of an insulating material.

The lower electrode via plug 185 may penetrate the upper cladding layer 110U vertically and may directly contact the first and/or second slabs 140 and 145 so as to be electrically connected to either of the first and second slabs 140 and 145. The lower electrode via plug 185 may include a metal or metal compound. Sides of the lower electrode via plug 185 may be surrounded by the upper cladding layer 110U formed of an insulating material.

The upper and lower electrode pads 190 and 195 may be formed on the upper cladding layer 110U so as to contact and/or cover upper parts of the upper and lower electrode via plugs 180 and 185. Each of the upper and lower electrode pads 190 and 195 may include a metal or metal compound.

In the optical switching device according to the present embodiment, when a voltage is applied to the optical switching device through the upper and lower electrode pads 190 and 195, the voltage may be applied to both top and bottom ends of the phase transition pattern 130 through the upper electrode 170 and the lower electrode region 175 via the upper and lower electrode via plugs 180 and 185. The amount of the carrier injected into the phase transition pattern 130 may be adjusted depending on a magnitude of the applied voltage. Thus, in the optical switching device according to the present embodiment, the phase transition pattern 130 is transformed into the metallic state from the insulating state or vice versa depending on the amount of the injected carrier, thereby turning on/off light transmitted through the optical waveguide 120.

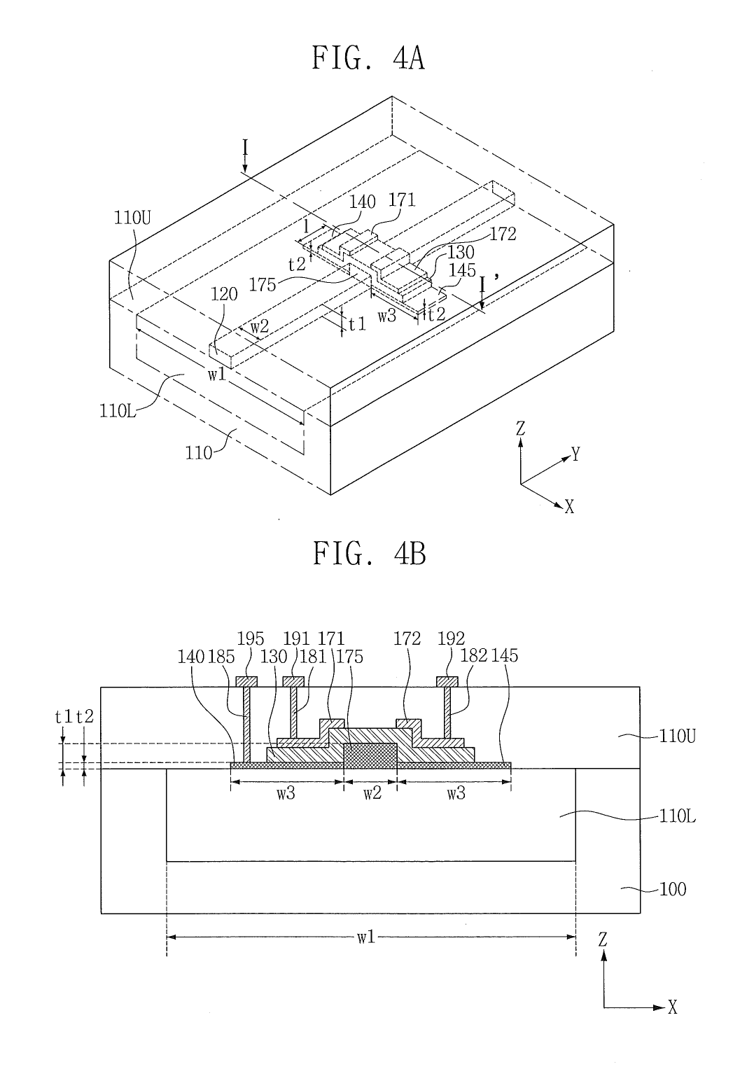

FIG. 4A is a partial perspective view schematically illustrating an optical switching device in accordance with some embodiments of the inventive concept, and FIG. 4B is a longitudinal cross-sectional view taken along line I-I′ illustrated in FIG. 4A. The optical switching device illustrated in FIGS. 4A and 4B is similar to the optical switching device illustrated in FIGS. 3A and 3B except first and second upper electrodes 171 and 172, first and second upper electrode via plugs 181 and 182, and first and second upper electrode pads 191 and 192. Thus, detailed descriptions of the same elements will be omitted.

Referring to FIGS. 4A and 4B, the optical switching device in accordance with some embodiments of the inventive concept may include a substrate 100, a lower cladding layer 110L, an optical waveguide 120, a lower electrode region 175, first and second slabs 140 and 145, a phase transition pattern 130, first and second upper electrodes 171 and 172, and an upper cladding layer 110U. The optical switching device in accordance with some embodiments of the inventive concept may further include first and second upper electrode via plugs 181 and 182, a lower electrode via plug 185, first and second upper electrode pas 191 and 192, and a lower electrode pad 195.

The first and second upper electrodes 171 and 172 may be formed on a part of a surface of the phase transition pattern 130 so as to be spaced apart from each other by a gap. For example, the first upper electrode 171 may be formed to surround parts of a top and side surfaces of the phase transition pattern 130, e.g., an upper part of a left side and a part of a left top surface of the phase transition pattern 130, and the second upper electrode 172 may be formed to surround other parts of the top and side surfaces of the phase transition pattern 130, e.g., an upper part of a right side and a part of a right top surface of the phase transition pattern 130. Each of the first and second upper electrodes 171 and 172 may have a horizontal width that is less than a half of the horizontal width of the phase transition pattern 130 in the first direction X and may have a thickness in the third direction Z. Each of the first and second upper electrodes 171 and 172 may have the same length as a length 1 of the phase transition pattern 130 in the second direction Y. The first and second upper electrodes 171 and 172 may be electrically connected to the phase transition pattern 130. Each of the first and second upper electrodes 171 and 172 may include a metal or metal compound. Each of the first and second upper electrodes 171 and 172 may include a transparent electrode, for example, an ITO.

The first and second upper electrode via plugs 181 and 182 may penetrate the upper cladding layer 110U vertically and may directly contact the first and second upper electrodes 171 and 172 so as to be electrically connected to the first and second upper electrodes 171 and 172. Each of the first and second upper electrode via plugs 181 and 182 may include a metal or metal compound. Sides of the first and second upper electrode via plugs 181 and 182 may be surrounded by the upper cladding layer 110U formed of an insulating material.

The first and second upper electrode pads 191 and 192 may be formed on the upper cladding layer 110U so as to contact and/or cover top surfaces of the first and second upper electrode via plugs 181 and 182. Each of the first and second upper electrode pads 191 and 192 may include a metal or metal compound.

In the optical switching device according to the present embodiment, when a voltage is applied to the optical switching device through a node in which the first and second upper electrode pads 191 and 192 are electrically connected to each other and the lower electrode pad 195, the voltage may be applied to both top and bottom ends of the phase transition pattern 130 through the first and second upper electrode via plugs 181 and 182 and the lower electrode via plug 185. The amount of a carrier injected into the phase transition pattern 130 may be adjusted depending on a magnitude of the applied voltage. Thus, in the optical switching device according to the present embodiment, the phase transition pattern 130 is transformed into the metallic state from the insulating state or vice versa depending on the amount of the injected carrier, thereby turning on/off light transmitted through the optical waveguide 120.

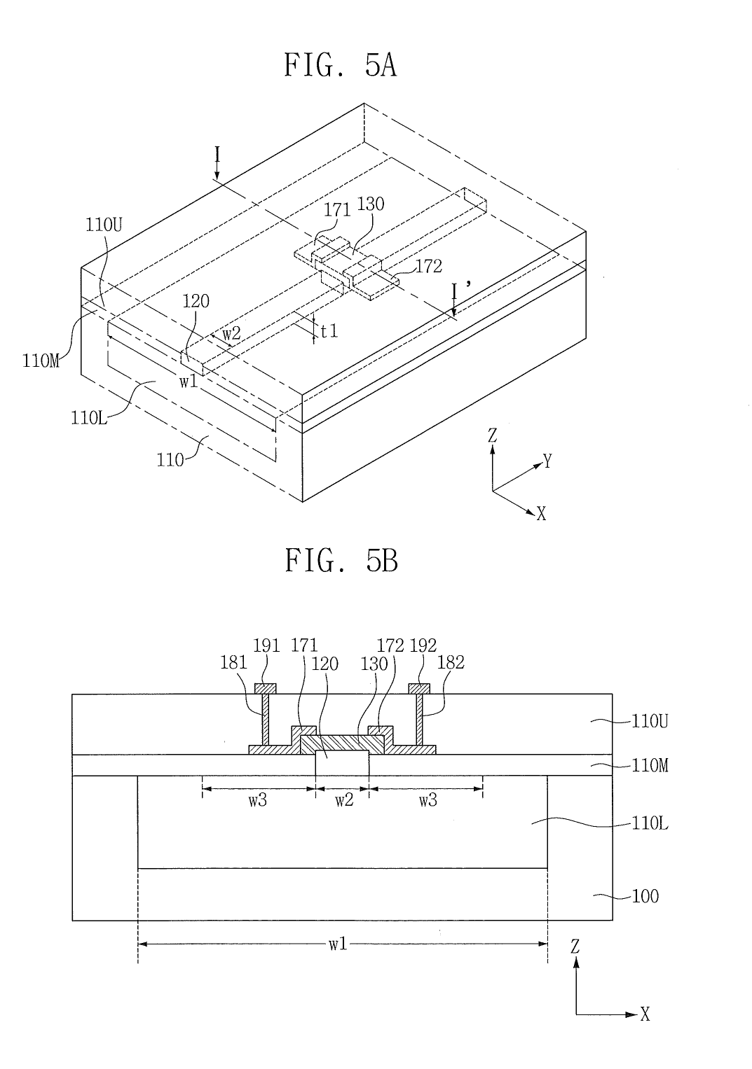

FIG. 5A is a partial perspective view schematically illustrating an optical switching device in accordance with some embodiments of the inventive concept, and FIG. 5B is a longitudinal cross-sectional view taken along line I-I′ illustrated in FIG. 5A. The present embodiment is a modified example of the optical switching device illustrated in FIGS. 4A and 4B. The optical switching device illustrated in FIGS. 5A and 5B is similar to the optical switching device of FIGS. 4A and 4B except that a lower electrode region 175 that serves as a lower electrode and first and second slabs 140 and 145 are omitted, except positions at which a phase transition pattern 130 and first and second upper electrodes 171 and 172 are to be formed due to this omission, and except insertion of an intermediate cladding layer 110M between an upper cladding layer 110U and a lower cladding layer 110L. Thus, detailed descriptions of the same elements will be omitted.

Referring to FIGS. 5A and 5B, the optical switching device in accordance with some embodiments of the inventive concept may include a substrate 100, a lower cladding layer 110L, an optical waveguide 120, a phase transition pattern 130, an intermediate cladding layer 110M, first and second upper electrodes 171 and 172, and an upper cladding layer 110U. The optical switching device in accordance with some embodiments of the inventive concept may further include first and second upper electrode via plugs 181 and 182 and first and second upper electrode pads 191 and 192.

The phase transition pattern 130 may be formed on a part of a surface of the optical waveguide 120. In detail, the phase transition pattern 130 may be formed to surround a part of a top surface and a part of upper parts of both sides of the optical waveguide 120. That is, the phase transition pattern 130 may have a horizontal width that is greater than or nearly equal to a horizontal width w2 of the optical waveguide 120 in the first direction X and may have a thickness in the third direction Z. The phase transition pattern 130 may have a length 1 in the second direction Y.

The intermediate cladding layer 110M may be formed on the substrate 100 and the lower cladding layer 110L so as to have a thickness that is less than a first thickness t1 of the optical waveguide 120. That is, the intermediate cladding layer 110M may be formed to surround lower parts of both sides of the optical waveguide 120. The intermediate cladding layer 110M may include a silicon oxide. The intermediate cladding layer 110M and the lower cladding layer 110L may include the same material so as to be materially connected to each other. The intermediate cladding layer 110M may have a lower refractive index than a refractive index of the optical waveguide 120.

The first and second upper electrodes 171 and 172 may be formed on parts of surfaces of the intermediate cladding layer 110M and the phase transition pattern 130 so as to be spaced apart from each other by a gap. For example, the first upper electrode 171 may be formed on the intermediate cladding layer 110M so as to surround parts of a top and side surfaces of the phase transition pattern 130, e.g., an upper part of a left side and a part of a left top surface of the phase transition pattern 130, and the second upper electrode 172 may be formed on the intermediate cladding layer 110M so as to surround other parts of the top and side surfaces of the phase transition pattern 130, e.g., an upper part of a right side and a part of a right top surface of the phase transition pattern 130. Each of the first and second upper electrodes 171 and 172 may include a metal or metal compound. Each of the first and second upper electrodes 171 and 172 may include a transparent electrode, for example, an ITO.

The upper cladding layer 110U may be formed on the intermediate cladding layer 110M, the first and second upper electrodes 171 and 172, and the phase transition pattern 130 so as to have a thickness. The upper cladding layer 110U may include a silicon oxide. The intermediate cladding layer 110M and the upper cladding layer 110U may include the same material so as to be materially connected to each other. The upper cladding layer 110U may have a lower refractive index than the refractive index of the optical waveguide 120. In FIG. 5B, the intermediate cladding layer 110M and the upper cladding layer 110U are marked by chain thin lines so as to differentiate therebetween.

In the present embodiment, the optical waveguide 120, the phase transition pattern 130, and the first and second upper electrodes 171 and 172 may be embedded or encapsulated by the lower cladding layer 110L, the intermediate cladding layer 110M, and the upper cladding layer 110U.

In the optical switching device according to the present embodiment, when a voltage is applied to the optical switching device through the first and second upper electrode pads 191 and 192, the voltage may be applied to both left and right ends of the phase transition pattern 130 through the first and second upper electrode via plugs 181 and 182. The amount of a carrier injected into the phase transition pattern 130 may be adjusted depending on a magnitude of the applied voltage. Thus, in the optical switching device according to the present embodiment, the phase transition pattern 130 is transformed into the metallic state from the insulating state or vice versa depending on the amount of the injected carrier, thereby turning on/off light transmitted through the optical waveguide 120.

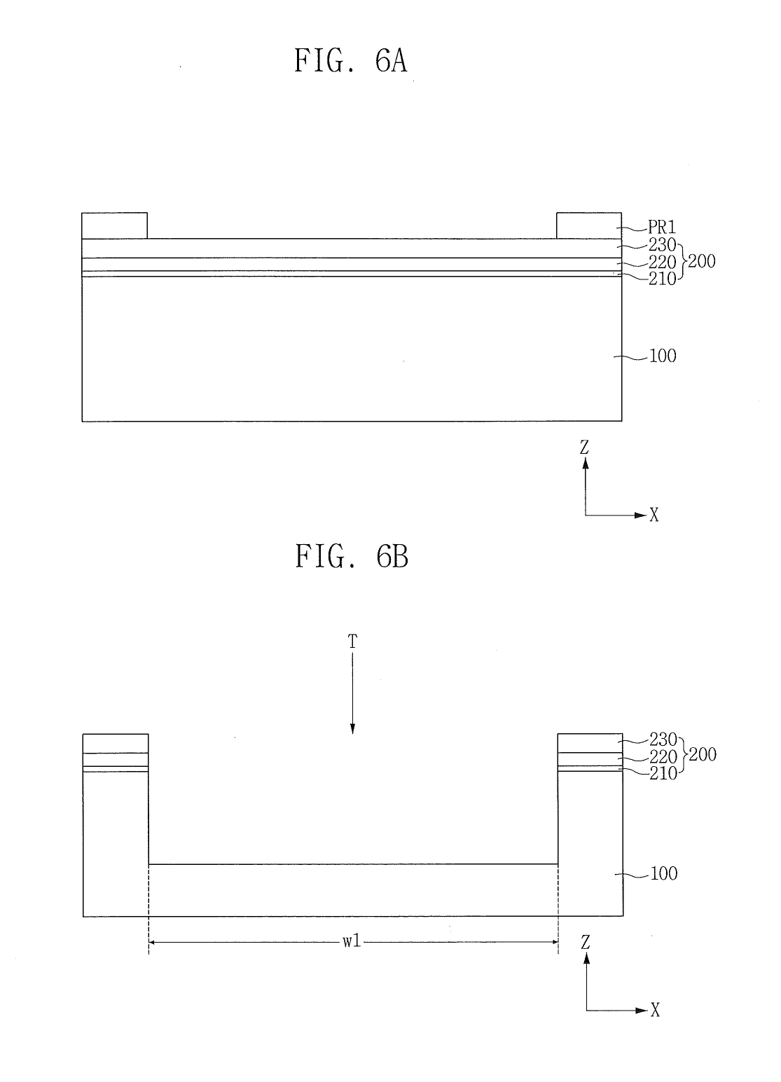

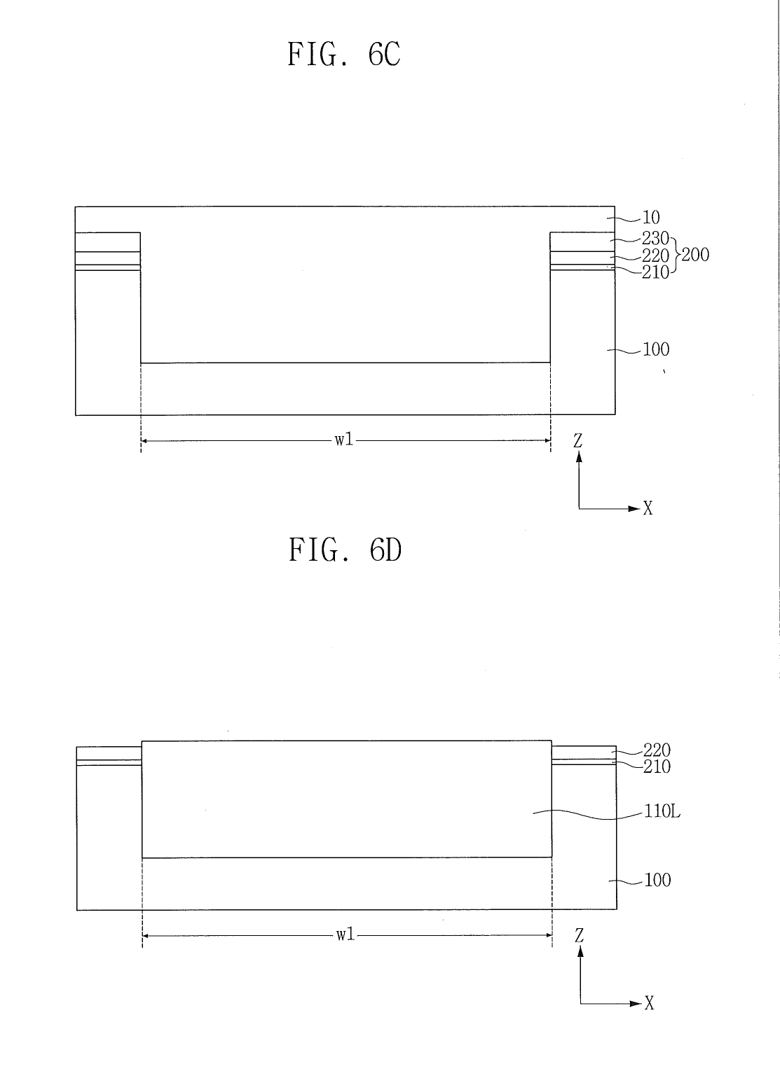

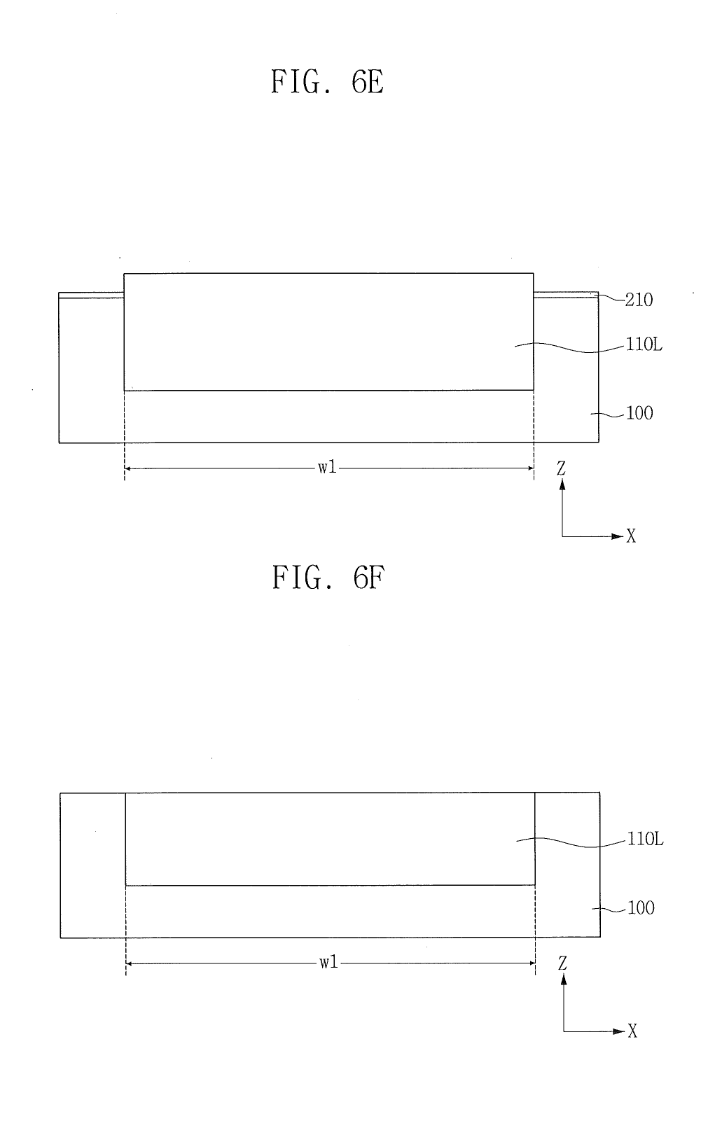

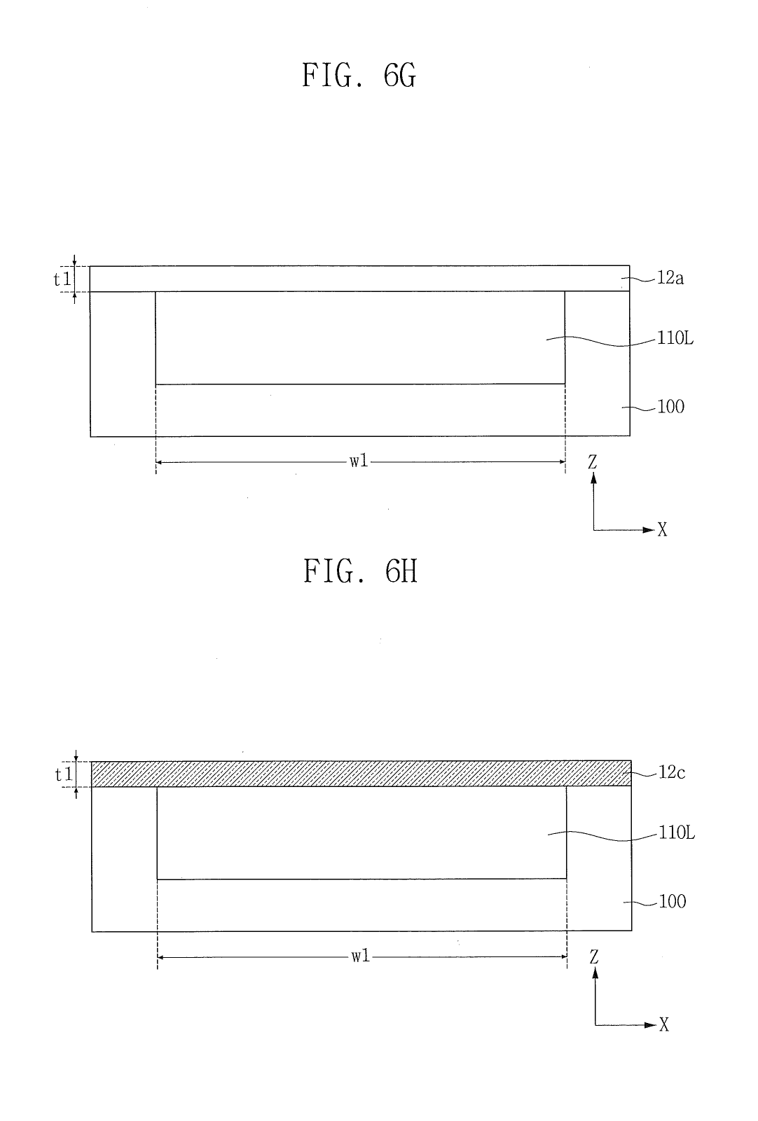

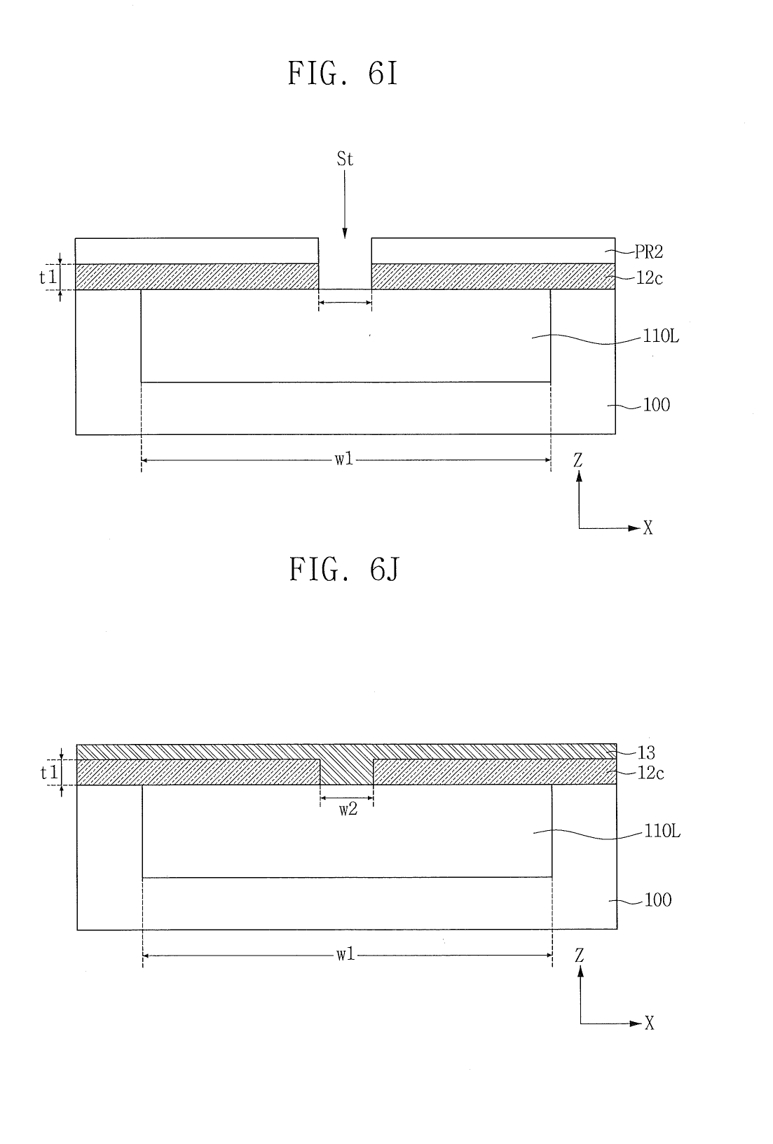

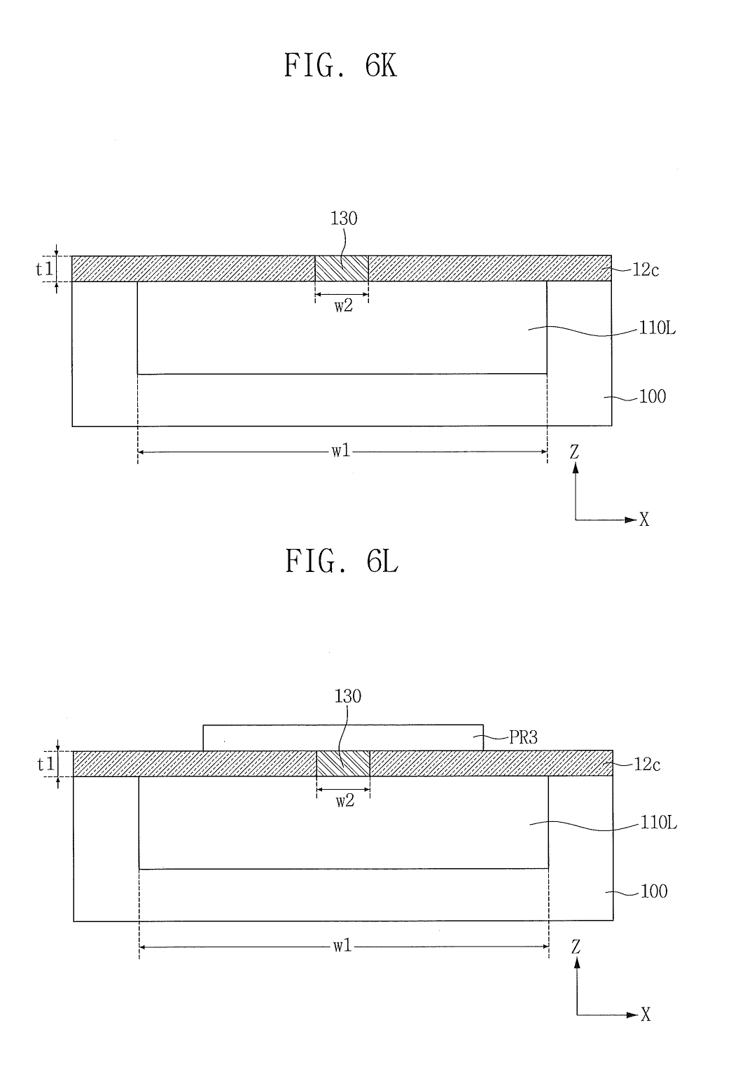

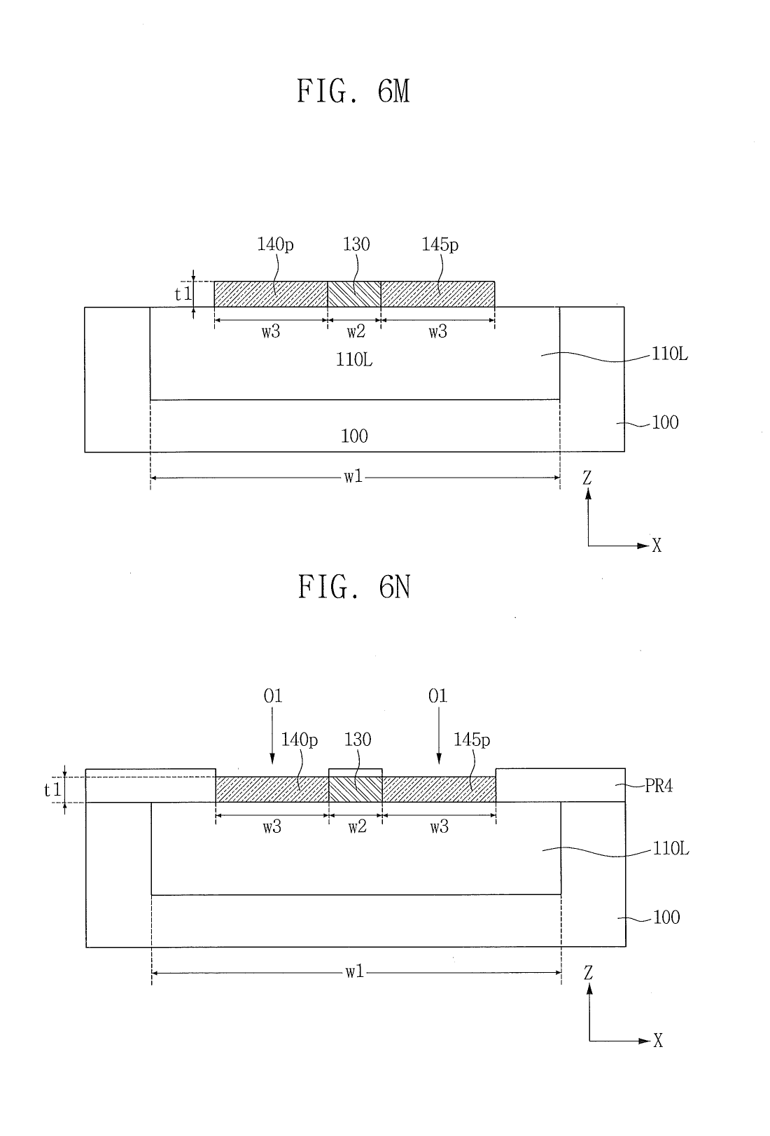

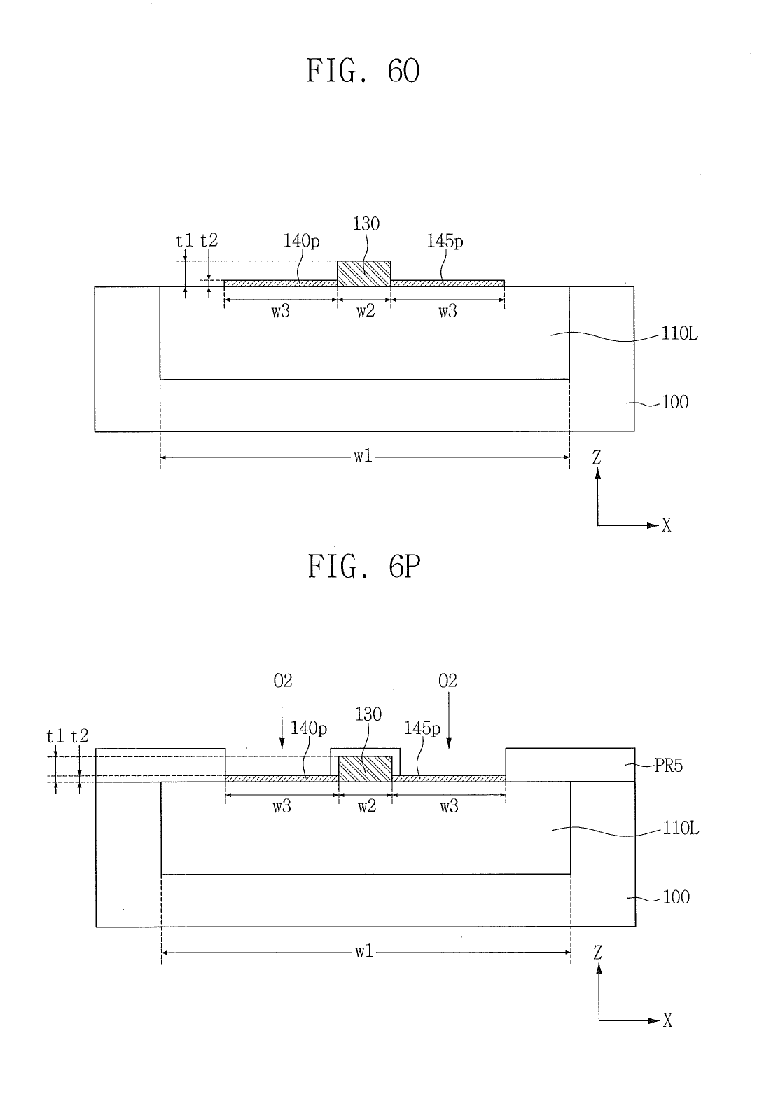

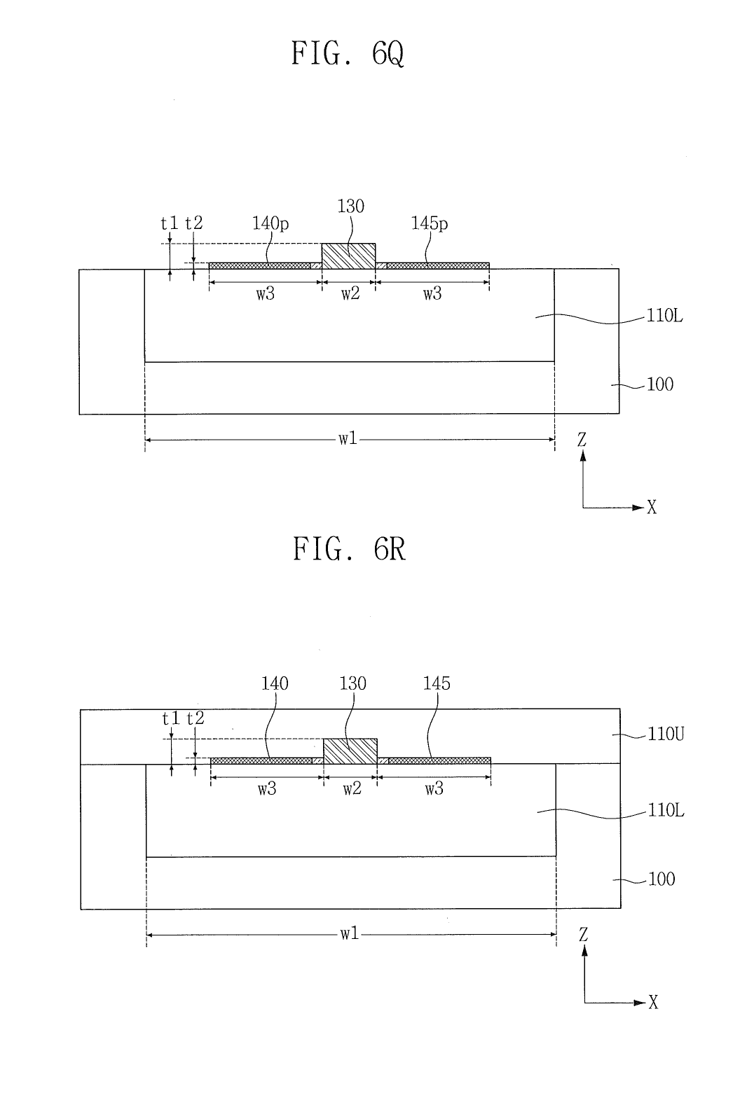

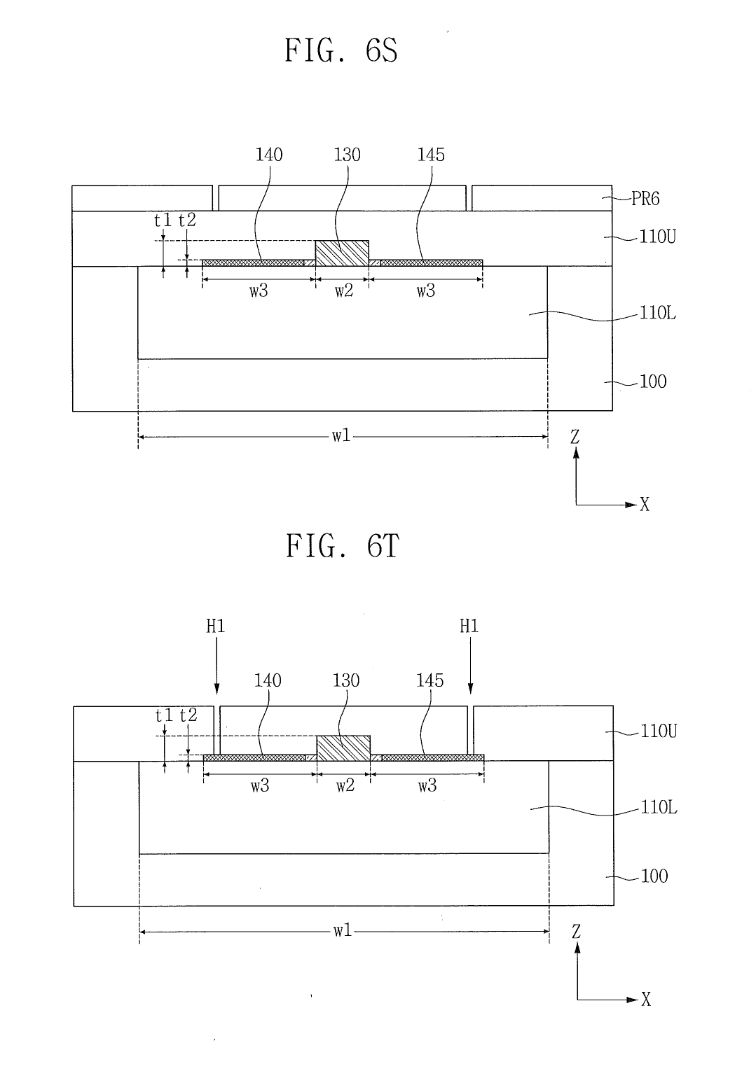

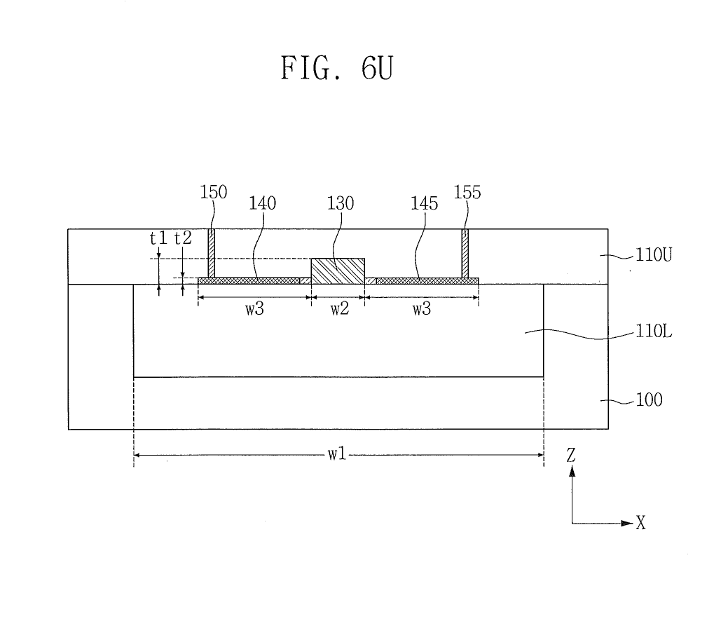

FIGS. 6A through 6U illustrate operations of a method of fabricating an optical switching device in accordance with some embodiments of the inventive concept and are longitudinal cross-sectional views taken along line I-I′ of FIG. 1A.

Referring to FIG. 6A, the method of fabricating an optical switching device in accordance with the embodiment of the inventive concept may include forming pad mask layers 200 and a first mask pattern PR1 on a substrate 100. The pad mask layers 200 may be formed partially or entirely on the substrate 100. The substrate 100 may be a bulk silicon wafer. The substrate 100 may include monocrystalline silicon. The pad mask layers 200 may include a silicon nitride, a silicon oxide, or a combination thereof. For example, the pad mask layers 200 may include a relatively thin silicon oxide layer 210, a relatively thicker silicon nitride layer 220, and a relatively thicker silicon oxide layer 230, which are formed on the substrate 100. The first mask pattern PR1 may define a trench T to be formed to provide a space in which the optical switching device according to embodiments of the inventive concept is to be formed. The first mask pattern PR1 may include an organic material, for example, a photoresist. The first mask pattern PR1 may include an inorganic material having etching selectivity with respect to the pad mask layers 200.

Referring to FIG. 6B, the method may include forming the trench T to be recessed into the substrate 100 by performing an etching process in which the first mask pattern PR1 is used as a patterning mask. A depth of the trench T may be about 1 micrometer (μm). The trench T may have a first horizontal width w1 in a first direction X and may extend in a second direction Y perpendicular to the first direction X.

Referring to FIG. 6C, the method may include forming a lower cladding material layer 10 by performing high density plasma chemical vapor deposition (HDP-CVD) and by filling an inside of the trench T with a lower cladding material. In this case, the lower cladding material layer 10 may be formed to fully fill the inside of the trench T and to sufficiently cover top surfaces of the pad mask layers 200. The lower cladding material layer 10 may include an insulating material. The lower cladding material layer 10 may include a silicon oxide.

Referring to FIGS. 6D through 6F, the method may include exposing the surface of the substrate 100 by performing a planarization process. In this process, the lower cladding material that remains in the trench T may be transformed into a lower cladding layer 110L. In detail, referring to FIG. 6D, the method may include exposing the surface of the silicon nitride layer 220 of the pad mask layers 200 by performing a chemical mechanical polishing (CMP) process. Subsequently, referring to FIG. 6E, the method may include removing the silicon nitride layer 220 by performing a wet etching process. Thereafter, referring to FIG. 6F, the method may include removing the silicon oxide layer 210 and exposing the surface of the substrate 100 by performing a dry etching or wet etching process. In the processes of FIGS. 6D through 6F, a top surface of the lower cladding layer 110L may be placed at a level that is the same as or similar to a level of a top surface of the substrate 100. The lower cladding layer 110L may include a silicon oxide.

Referring to FIG. 6G, the method may include partially or entirely forming an amorphous material layer 12a on surfaces of the substrate 100 and the lower cladding layer 110L. The amorphous material layer 12a may be formed on the substrate 100 and the lower cladding layer 110L to a sufficient thickness by performing a deposition process. That is, the thickness of the amorphous material layer 12a may be a first thickness t1 in a third direction Z perpendicular to a plane formed in the first direction X and the second direction Y. The amorphous material layer 12a may include amorphous silicon or polycrystalline silicon.

Referring to FIG. 6H, the method may include monocrystallizing the amorphous material layer 12a into a monocrystalline material layer 12c. The monocrystallization process may be performed using laser, thermal treatment, a rapid thermal process (RTP), and/or an annealing process using a furnace. The monocrystallization process using laser may be faster than other processes and may have a wide range of monocrystallization. According to embodiments of the inventive concept, surfaces of the substrate 100 may be used as a monocrystallization seed.

Referring to FIG. 6I, the method may include forming a second mask pattern PR2 on the monocrystalline material layer 12c and forming a phase transition pattern cavity or space St to be recessed into the monocrystalline material layer 12c by performing an etching process in which the second mask pattern PR2 is used as a patterning mask, so that a part of a surface of the lower cladding layer 110L may be exposed. The phase transition pattern space St may have a second horizontal width w2 that is less than the first horizontal width w1 in the first direction X and may have the first thickness t1 in the third direction Z. The phase transition pattern space St may have a length 1 in the second direction Y by further referring to FIG. 1A. The second mask pattern PR2 may include an organic material, for example, a photoresist.

Referring to FIG. 6J, the method may include forming a phase transition material layer 13 by removing the second mask pattern PR2, performing a deposition process to fill an inside of the phase transition pattern space St with a phase transition material. In this case, the phase transition material layer 13 may be formed to fully fill the inside of the phase transition pattern space St and to sufficiently cover the top surface of the monocrystalline material layer 12c. The phase transition material layer 13 may include a vanadium oxide.

Referring to FIG. 6K, the method may include exposing the surface of the monocrystalline material layer 12c by performing the planarization process, such as CMP. In this process, the phase transition material that remains in the phase transition pattern space St may be transformed into or otherwise defines a phase transition pattern 130. Thus, the phase transition pattern 130 may have the second horizontal width w2 in the first direction X, may have the first thickness t1 in the third direction Z, and may have a length 1 (see FIG. 1A) in the second direction Y. The phase transition pattern 13Q may include a vanadium oxide.

Referring to FIG. 6L, the method may include forming a third mask pattern PR3 on a part of the monocrystalline material layer 12c and the phase transition pattern 130. The third mask pattern PR3 may define an optical waveguide 120 and first and second preliminary slabs 140p and 145p (see FIG. 6M). The third mask pattern PR3 may include an organic material, for example, a photoresist.

Referring to FIG. 6M, the method may include forming the optical waveguide 120 and the first and second preliminary slabs 140p and 145p by removing a part of the monocrystalline material layer 12c so that the surfaces of the lower cladding layer 110L and the substrate 100 may be exposed using an etching process in which the third mask pattern PR3 is used as a patterning mask. The optical waveguide 120 may have the second horizontal width w2 in the first direction X and may have the first thickness t1 in the third direction Z. The optical waveguide 120 may extend in the second direction Y by further referring to FIG. 1A. The first and second preliminary slabs 140p and 145p may be formed at both sides of the phase transition pattern 130 so as to have a horizontal width in the first direction X. For example, each of the first and second preliminary slabs 140p and 145p may have a third horizontal width w3 that is less than the first horizontal width w1 and greater than the second horizontal width w2 in the first direction X. Each of the first and second preliminary slabs 140p and 145p may have the first thickness t1 in the third direction Z and may have the same length as the length 1 (see FIG. 1A) of the phase transition pattern 130 in the second direction Y. The optical waveguide 120 and the first and second preliminary slabs 140p and 145p may include the same material so as to be materially connected to each other.

Referring to FIG. 6N, the method may include forming a fourth mask pattern PR4 having a first opening O1 corresponding to the first and second preliminary slabs 140p and 145p on the substrate 100, the lower cladding layer 110L, the optical waveguide 120, and the phase transition pattern 130. The fourth mask pattern PR4 may include an organic material, for example, a photoresist.

Referring to FIG. 6O, the method may include forming first and second slabs 140 and 145 by recessing upper parts of the first and second preliminary slabs 140p and 145p using an etching process in which the fourth mask pattern PR4 is used as a patterning mask. The first and second slabs 140 and 145 may have the third horizontal width w3 in the first direction X and may have a second thickness t2 that is less than the first thickness t1 in the third direction Z. Each of the first and second slabs 140 and 145 may have the same length as the length 1 of the phase transition pattern 130 in the second direction Y by further referring to FIG. 1A. In this process, a part of sides of the phase transition pattern 130 may be exposed.

Referring to FIG. 6P, the method may include forming a fifth mask pattern PR5 on the substrate 100, the lower cladding layer 110L, the optical waveguide 120, and the phase transition pattern 130, wherein the fifth mask pattern PR5 has a second opening O2 with a horizontal width in the first direction X that is less than that of the first opening O1, the second opening O2 corresponds to the first and second slabs 140 and 145, and the fifth mask pattern PR5 surrounds the exposed upper part and part of sides of the phase transition pattern 130. The fifth mask pattern PR5 may include an organic material, for example, a photoresist.

Referring to FIG. 6Q, the method may include doping impurities into the exposed first and second slabs 140 and 145 using the fifth mask pattern PR5. Each of the first and second slabs 140 and 145 may include doped silicon. Forming the first and second slabs 140 and 145 may include an ion implantation process. The first and second slabs 140 and 145 may be electrically connected to the phase transition pattern 130. Each of the first and second slabs 140 and 145 may include a P-type impurity and/or an N-type impurity, defining conductive elements that are configured to apply a voltage or other stimulus to the phase transition pattern 130 to change the phase thereof.

Referring to FIG. 6R, the method may include forming an upper cladding layer 110U on the substrate 100, the lower cladding layer 110L, the optical waveguide 120, the phase transition pattern 130, and the first and second slabs 140 and 145 to a sufficient thickness by performing a deposition process. The upper cladding layer 110U may include the same material so as to be materially connected to the lower cladding layer 110L. The upper cladding layer 110U may include a silicon oxide.

Referring to FIG. 6S, the method may include forming a sixth mask pattern PR6 for defining via plug regions corresponding to the first and second slabs 140 and 145 on the upper cladding layer 110U. The sixth mask pattern PR6 may include an organic material, for example, a photoresist.

Referring to FIG. 6T, the method may include forming first and second slab via holes H1 through which surfaces of the first and second slabs 140 and 145 are exposed, by penetrating the upper cladding layer 110U using an etching process in which the sixth mask pattern PR6 is used as a patterning mask.

Referring to FIG. 6U, the method may include forming first and second slab via plugs 150 and 155 to directly contact the first and second slabs 140 and 145 by filling each of insides of the first and second slab via holes H1 with a conductive material. Each of the first and second slab via plugs 150 and 155 may include a metal or metal compound. Outer sides of the first and second slab via plugs 150 and 155 may be surrounded by the upper cladding layer 110U.

Subsequently, by further referring to FIG. 1B, the method may further include forming first and second slab pads 160 and 165 on the upper cladding layer 110U so as to be electrically connected to the first and second slab via plugs 150 and 155. Each of the first and second slab pads 160 and 165 may include a metal or metal compound.

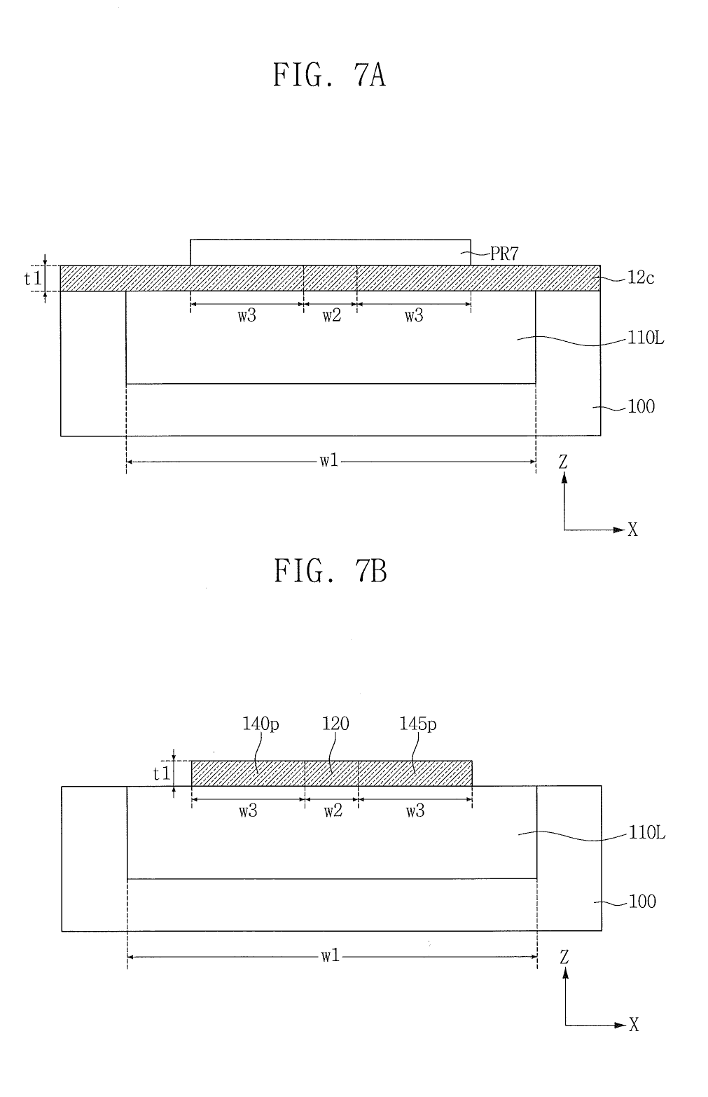

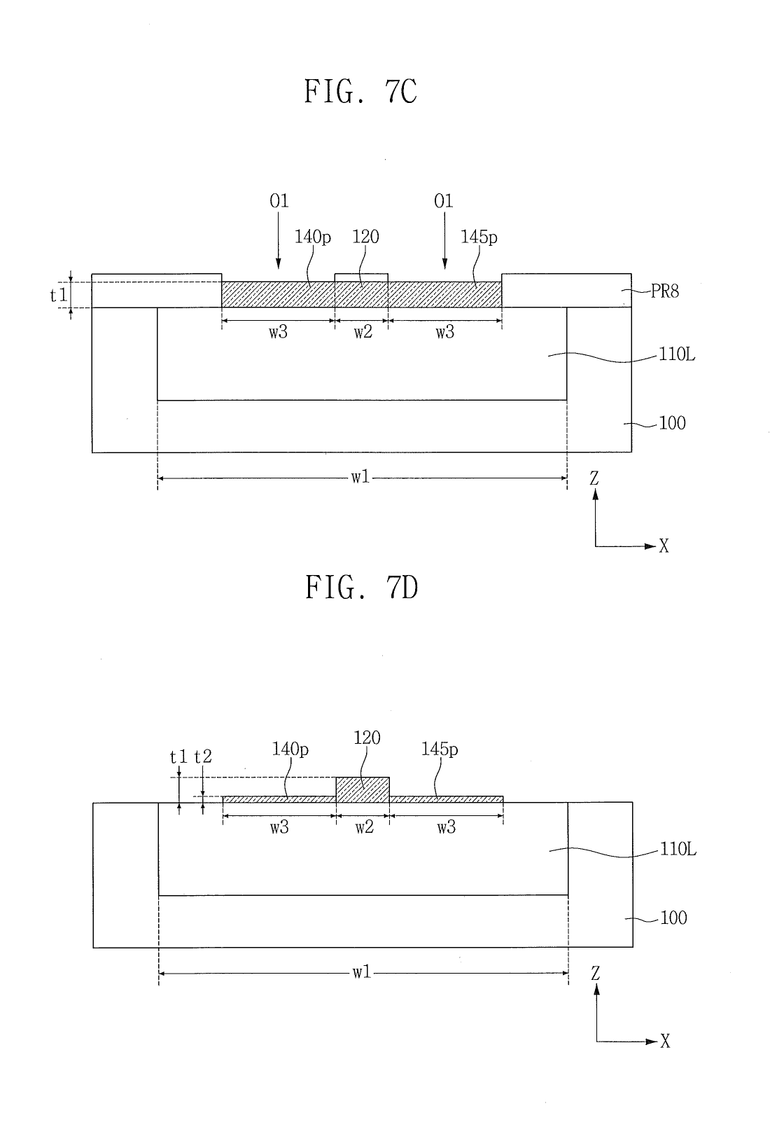

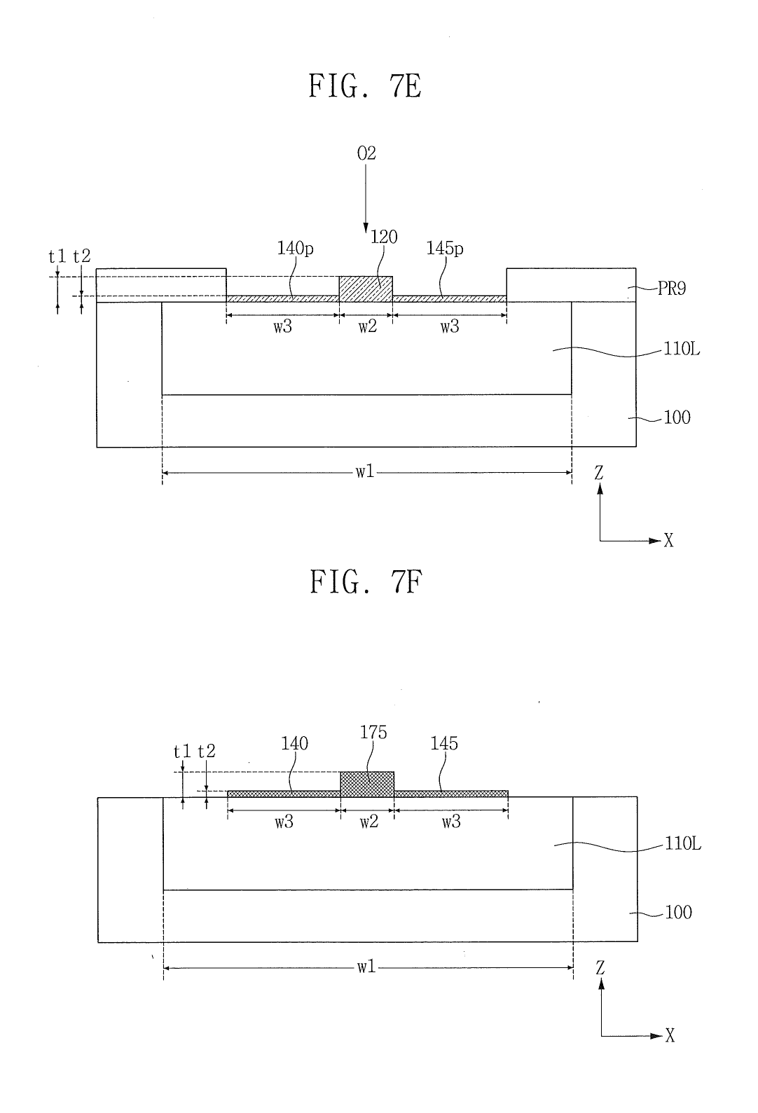

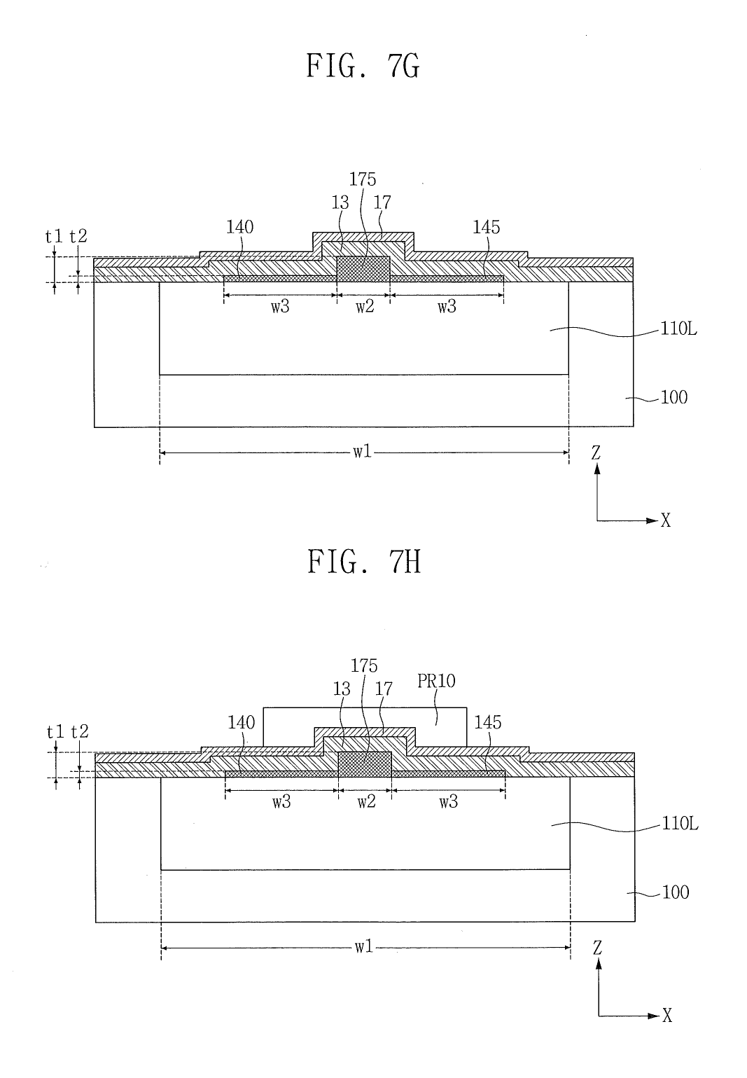

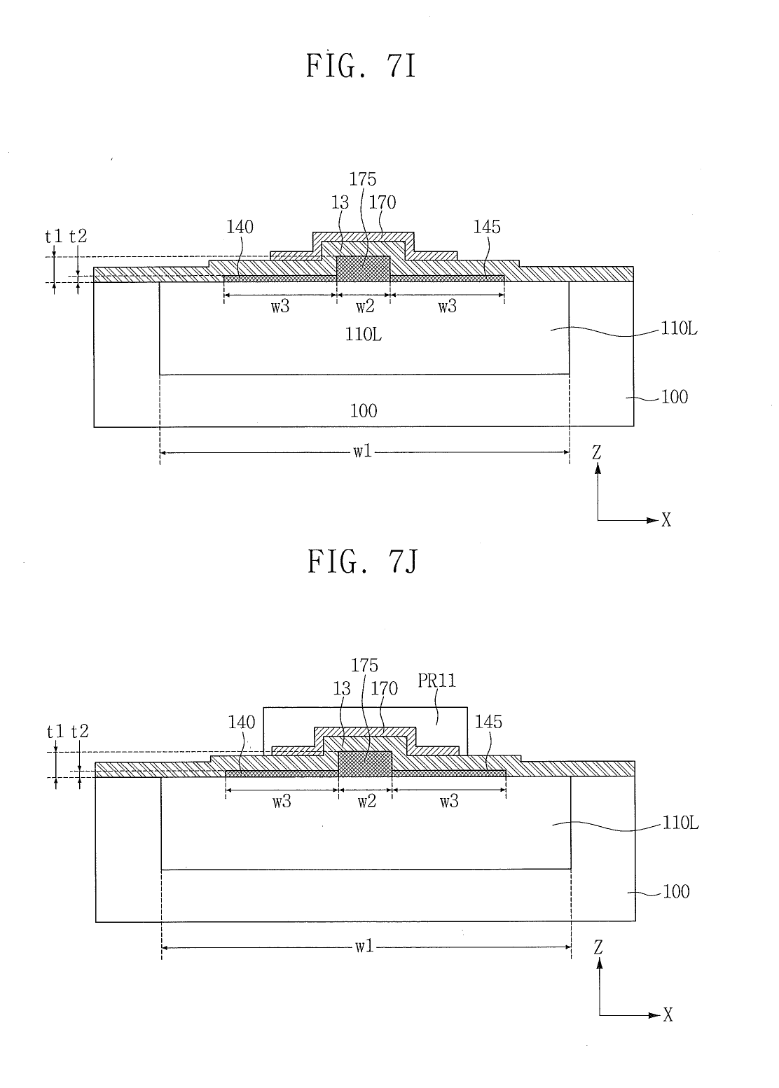

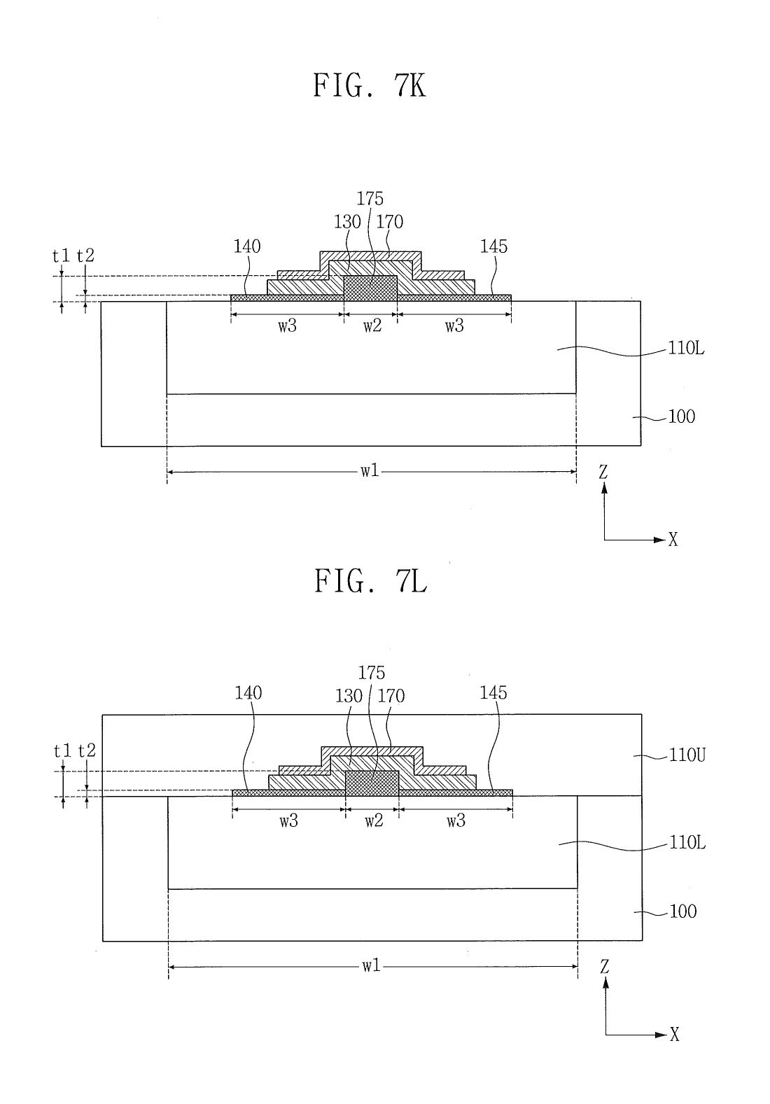

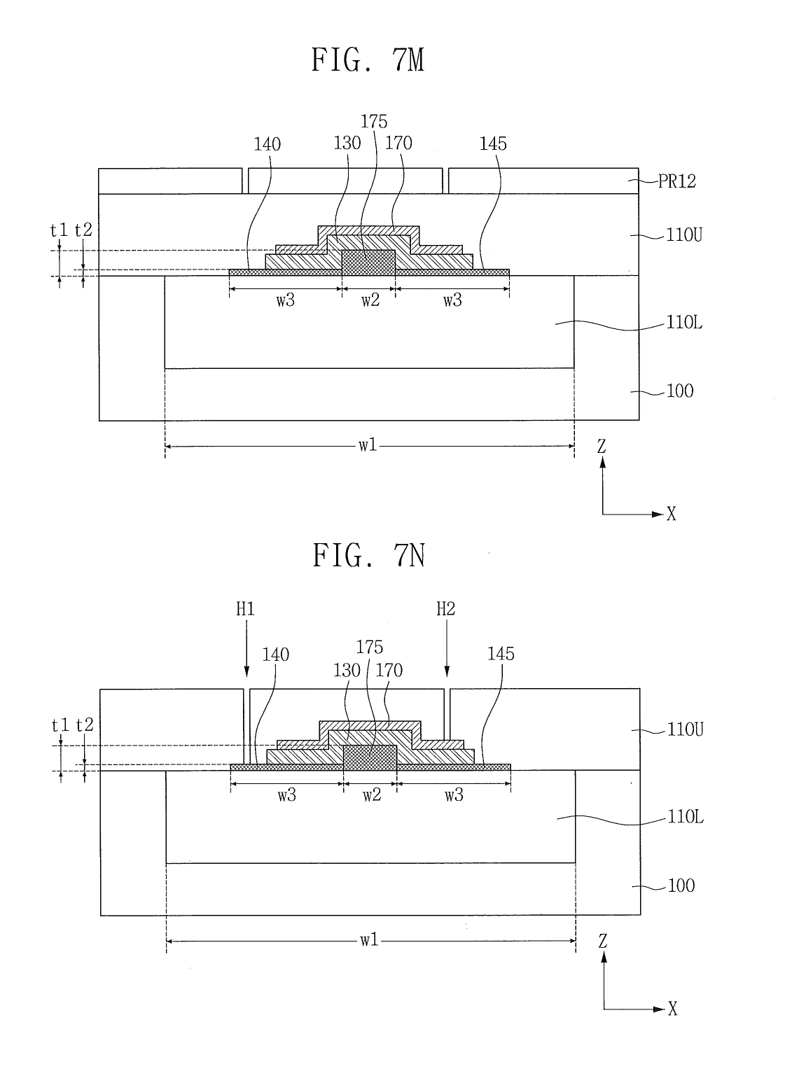

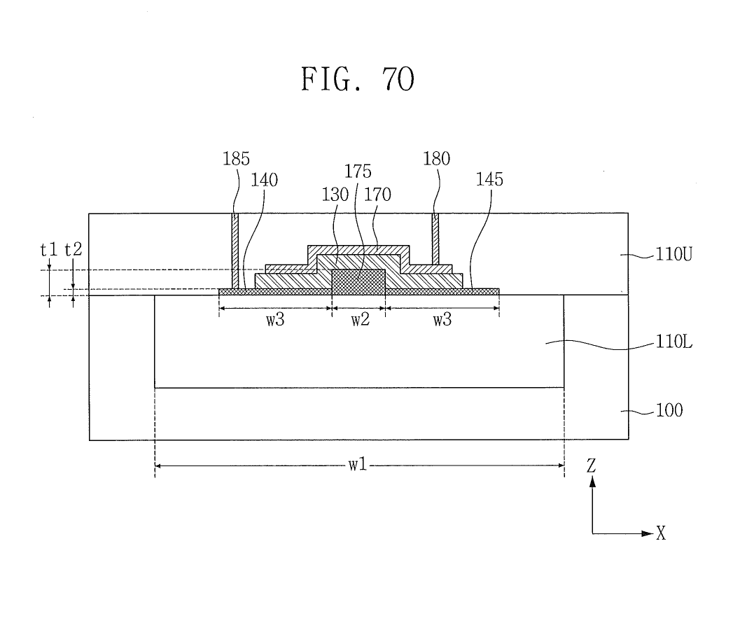

FIGS. 7A through 7O illustrate operations of a method of fabricating an optical switching device in accordance with some embodiments of the inventive concept and are longitudinal cross-sectional views taken along line I-I′ of FIG. 3A.

Referring to FIGS. 6A through 6H and FIG. 7A, the method of fabricating an optical switching device in accordance with some embodiments of the inventive concept may include forming a seventh mask pattern PR7 for defining an optical waveguide 120 and first and second preliminary slabs 140p and 145p on the monocrystalline material layer 12c. The seventh mask pattern PR7 may include an organic material, for example, a photoresist.

Referring to FIG. 7B, the method may include forming the optical waveguide 120 and the first and second preliminary slabs 140p and 145p by performing an etching process in which the seventh mask pattern PR7 is used as a patterning mask. The optical waveguide 120 may have a second horizontal width w2 that is less than the first horizontal width w1 in the first direction X and may have the first thickness t1 in the third direction Z. The optical waveguide 120 may extend in the second direction Y by further referring to FIG. 3A. Each of the first and second preliminary slabs 140p and 145p may be formed to have a horizontal width in the first direction X. For example, each of the first and second preliminary slabs 140p and 145p may have a third horizontal width w3 that is less than the first horizontal width w1 and greater than the second horizontal width w2 in the first direction X. Each of the first and second preliminary slabs 140p and 145p may have a length 1 in the second direction Y by further referring to FIG. 3A. The optical waveguide 120 and the first and second preliminary slabs 140p and 145p may include the same material so as to be materially connected to each other.

Referring to FIG. 7C, the method may include forming an eighth mask pattern PR8 having a first opening O1 corresponding to the first and second preliminary slabs 140p and 145p on the substrate 100, the lower cladding layer 110L, and the optical waveguide 120. The eighth mask pattern PR8 may include an organic material, for example, a photoresist.

Referring to FIG. 7D, the method may include forming first and second slabs 140 and 145 by recessing upper parts of the first and second preliminary slabs 140p and 145p using an etching process in which the eighth mask pattern PR8 is used as a patterning mask. Each of the first and second slabs 140 and 145 may have the third horizontal width w3 that is less than the first horizontal width w1 and greater than the second horizontal width w2 in the first direction X, may have a second thickness t2 that is less than the first thickness t1 in the third direction Z, and may have the length 1 (see FIG. 3A) in the second direction Y.

Referring to FIG. 7E, the method may include forming a ninth mask pattern PR9 having a second opening O2 corresponding to the first and second slabs 140 and 145 and a part of the optical waveguide 120 (hereinafter, referred to as a lower electrode region 175) that corresponds to the length 1 (see FIG. 3A) in the second direction Y of the first and second slabs 140 and 145 on the substrate 100, the lower cladding layer 110L, and the optical waveguide 120. The ninth mask pattern PR9 may include an organic material, for example, a photoresist.

Referring to FIG. 7F, the method may include doping impurities into the exposed first and second slabs 140 and 145 and the lower electrode region 175 using the ninth mask pattern PR9. The first and second slabs 140 and 145 and the lower electrode region 175 may include the same material so as to be materially connected to each other. The lower electrode region 175 may have the second horizontal width w2 in the first direction X, the first thickness t1 in the third direction Z, and the same length as the length 1 (see FIG. 3A) of each of the first and second slabs 140 and 145 in the second direction Y. Each of the first and second slabs 140 and 145 and the lower electrode region 175 may include doped silicon. Each of the first and second slabs 140 and 145 and the lower electrode region 175 may include a P-type impurity and/or an N-type impurity to define conductive elements that are configured to apply a voltage or other stimulus to the phase transition pattern 130 to change the phase thereof. Forming the first and second slabs 140 and 145 and the lower electrode region 175 may include an ion implantation process.

Referring to FIG. 7G, the method may include partially or entirely forming a phase transition material layer 13 and an upper electrode layer 17 on surfaces of the substrate 100, the lower cladding layer 110L, the first and second slabs 140 and 145, and the lower electrode region 175.

Referring to FIG. 7H, the method may include forming a tenth mask pattern PR10 that is disposed perpendicular to the lower electrode region 175 and parts of the first and second slabs 140 and 145 on the upper electrode layer 17. The tenth mask pattern PR10 may include an organic material, for example, a photoresist.

Referring to FIG. 7I, the method may include forming an upper electrode 170 by etching the upper electrode layer 17 by performing an etching process in which the tenth mask pattern PR10 is used as a patterning mask. The upper electrode 170 may include a metal or metal compound. The upper electrode 170 may include a transparent electrode, for example, an ITO.

Referring to FIG. 7J, the method may include forming an eleventh mask pattern PR11 for covering the upper electrode 170 on the phase transition material layer 13. The eleventh mask pattern PR11 may include an organic material, for example, a photoresist.

Referring to FIG. 7K, the method may include forming a phase transition pattern 130 and exposing the first and second slabs 140 and 145 by etching the phase transition material layer 13 by performing an etching process in which the eleventh mask pattern PR11 is used as a patterning mask. The phase transition pattern 130 may include a vanadium oxide. Although the phase transition pattern 130 and the upper electrode 170 are formed in the form of stairs on the first and second slabs 140 and 145, aspects of the inventive concept are not limited thereto, and sides of the phase transition pattern 130 and the upper electrode 170 may have the same horizontal width in the first direction X.

Referring to FIG. 7L, the method may include forming an upper cladding layer 110U for covering the first and second slabs 140 and 145, the phase transition pattern 130, and the upper electrode 170 on the substrate 100 and the lower cladding layer 110L by performing a deposition process. The upper cladding layer 110U may include the same material so as to be materially connected to the lower cladding layer 110L. The upper cladding layer 110U may include a silicon oxide.

Referring to FIG. 7M, the method may include a twelfth mask pattern PR12 for defining via plug regions corresponding to either of the first and second slabs 140 and 145 and the upper electrode 170 on the upper cladding layer 110U. The twelfth mask pattern PR12 may include an organic material, for example, a photoresist.

Referring to FIG. 7N, the method may include forming a slab via hole H1 to directly contact either of the first and second slabs 140 and 145 and an upper electrode via hole H2 to directly contact the upper electrode 170 by penetrating the upper cladding layer 110U using an etching process in which the twelfth mask pattern PR12 is used as a patterning mask.

Referring to FIG. 7O, the method may include forming a slab via plug 185 and an upper electrode via plug 180 by filling an inside of the slab via hole H1 and an inside of the upper electrode via hole H2 with a conductive material. Each of the slab via plug 185 and the upper electrode via plug 180 may include a metal or metal compound. Sides of the slab via plug 185 and the upper electrode via plug 180 may be surrounded by the upper cladding layer 110U.

Subsequently, further referring to FIG. 3B, the method may further include forming a slab pad 195 and an upper electrode pad 190 to be respectively electrically connected to the slab via plug 185 and the upper electrode via plug 180 on the upper cladding layer 110U. Each of the slab pad 195 and the upper electrode pad 190 may include a metal or metal compound.

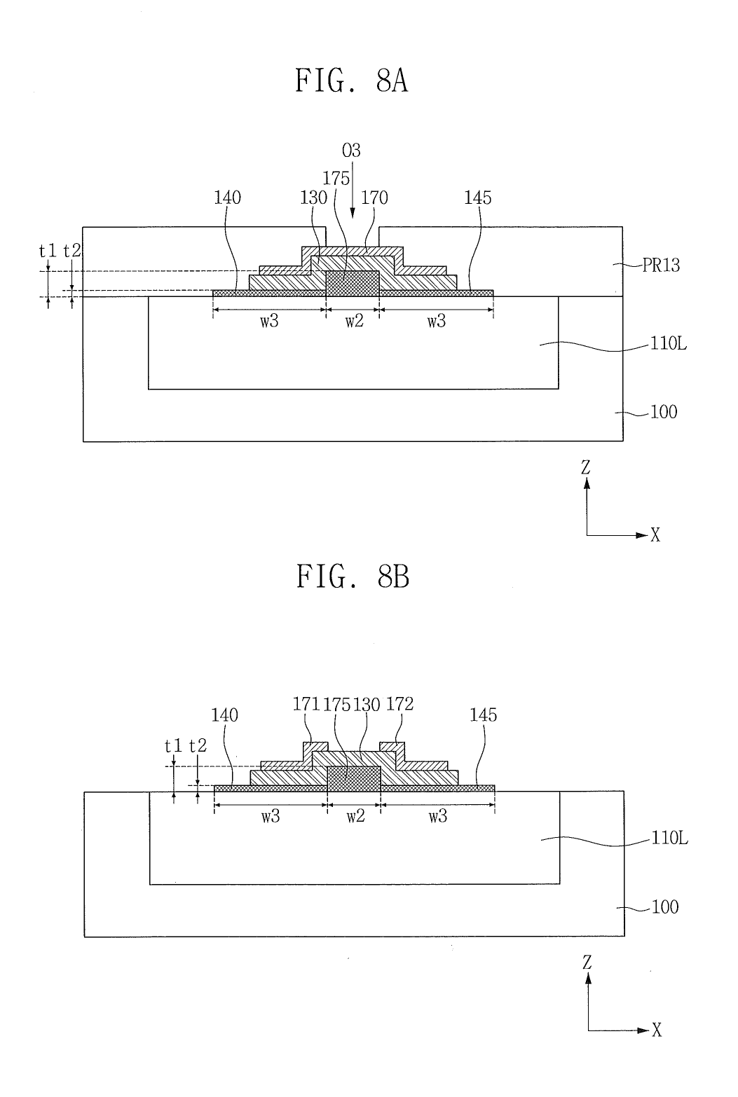

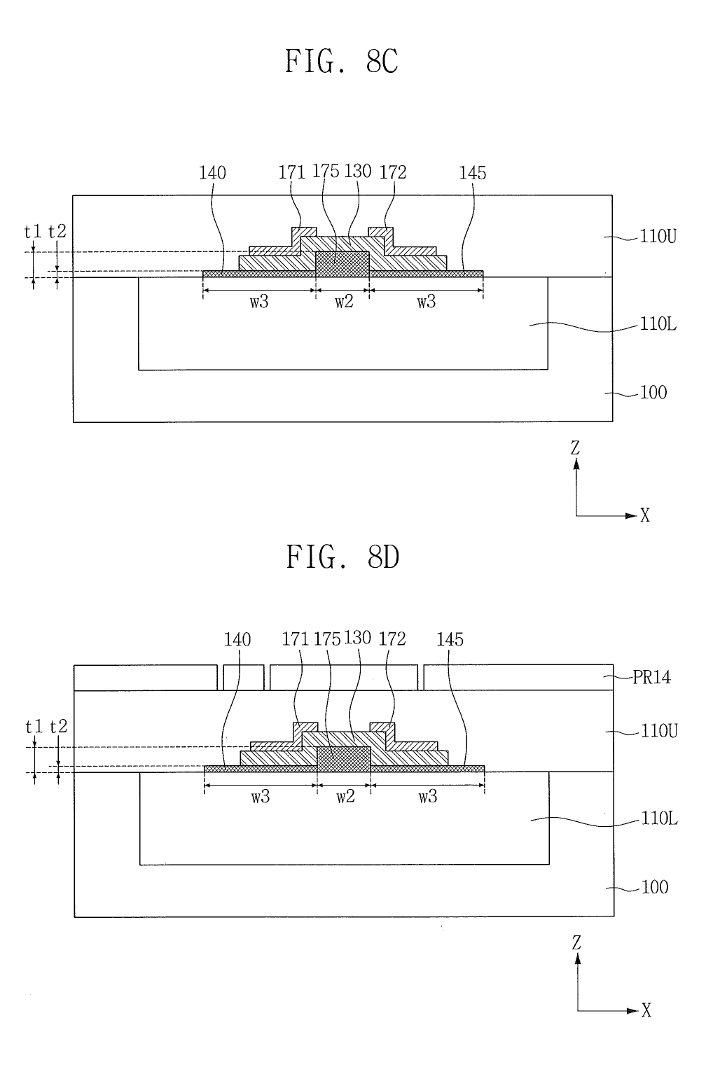

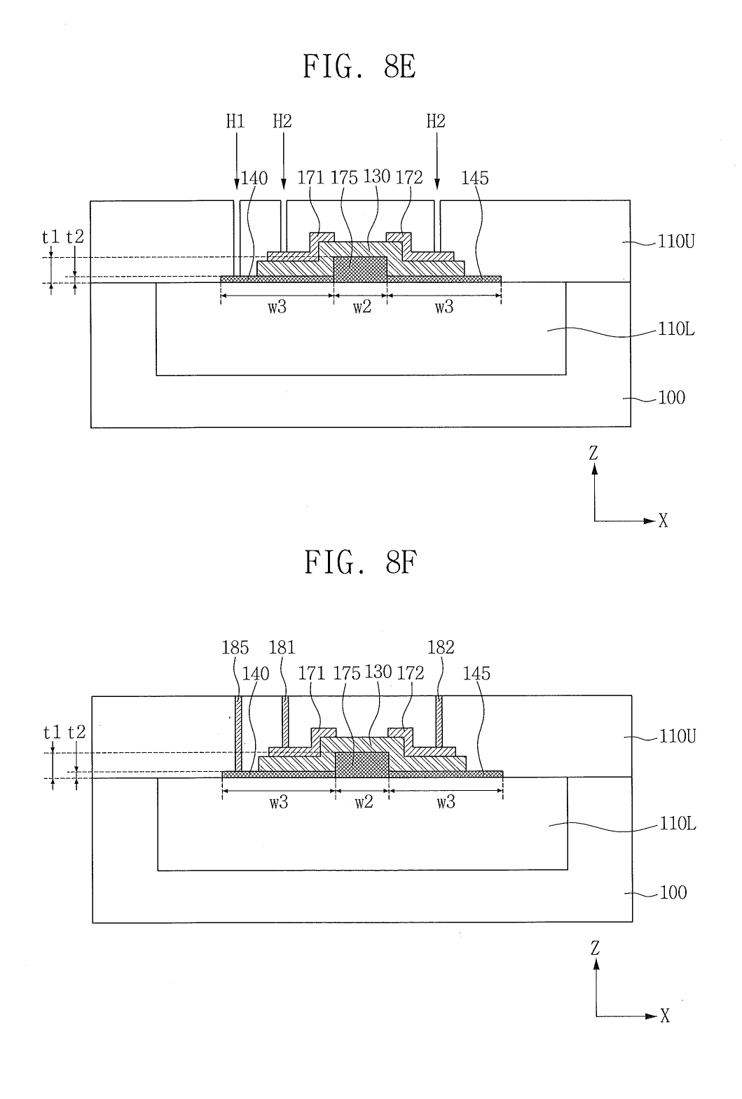

FIGS. 8A through 8F illustrate operations of a method of fabricating an optical switching device in accordance with some embodiments of the inventive concept and are longitudinal cross-sectional views taken along line I-I′ of FIG. 4A.

Referring to FIGS. 6A through 6H, FIGS. 7A through 7K, and FIG. 8A, the method of fabricating an optical switching device in accordance with some embodiments of the inventive concept may include forming a thirteenth mask pattern PR13 having a third opening O3 through which a part of a top surface of the upper electrode 170 is exposed, on the substrate 100, the lower cladding layer 110L, the first and second slabs 140 and 145, the phase transition pattern 130, and the upper electrode 170. The thirteenth mask pattern PR13 may include an organic material, for example, a photoresist.

Referring to FIG. 8B, the method may include exposing a part of a top surface of the phase transition pattern 130 by performing an etching process in which the thirteenth mask pattern PR13 is used as a patterning mask. In this process, the upper electrode 170 may be formed to be separated into first and second upper electrodes 171 and 172 that are spaced apart from each other by a gap. Each of the first and second upper electrodes 171 and 172 may include a metal or metal compound. Each of the first and second upper electrodes 171 and 172 may include a transparent electrode, for example, an ITO.

Referring to FIG. 8C, the method may include forming an upper cladding layer 110U on the substrate 100 and the lower cladding layer 110L by performing a deposition process so as to cover the first and second slabs 140 and 145, the phase transition pattern 130, and the first and second upper electrodes 171 and 172. The upper cladding layer 110U may include the same material so as to be materially connected to the lower cladding layer 110L. The upper cladding layer 110U may include a silicon oxide.

Referring to FIG. 8D, the method may include forming a fourteenth mask pattern PR14 for defining via plug regions corresponding to either of the first and second slabs 140 and 145 and the first and second upper electrodes 171 and 172 on the upper cladding layer 110U. The fourteenth mask pattern PR14 may include an organic material, for example, a photoresist.

Referring to FIG. 8E, the method may include forming a slab via hole H1 to directly contact either of the first and second slabs 140 and 145 and upper electrode via holes H2 to directly contact the first and second upper electrodes 171 and 172 by penetrating the upper cladding layer 110U using an etching process in which the fourteenth mask pattern PR14 is used as a patterning mask.

Referring to FIG. 8F, the method may include forming a slab via plug 185 and first and second upper electrode via plugs 181 and 182 by filling an inside of the slab via hole H1 and insides of the upper electrode via holes H2 with a conductive material. Each of the slab via plug 185 and the first and second upper electrode via plugs 181 and 182 may include a metal or metal compound. Sides of the slab via plug 185 and the first and second upper electrode via plugs 181 and 182 may be surrounded by the upper cladding layer 110U.

Subsequently, further referring to FIG. 4B, the method may include forming a slab pad 195 and first and second upper electrode pads 191 and 192 to be electrically connected to the slab via plug 185 and the first and second upper electrode via plugs 181 and 182 on the upper cladding layer 110U. Each of the slab pad 195 and the first and second upper electrode pads 191 and 192 may include a metal or metal compound.

In accordance with the embodiment of the inventive concept, since light transmitted through the optical waveguide 120 may be turned on/off by the phase transition pattern 130, which is formed within or on the optical waveguide 120 and a phase of which is transformed into a metallic state from an insulating state or vice versa depending on the amount of a carrier injected into the phase transition pattern 130, high speed/low power consumption/miniaturization of the optical switching device may be achieved, and a degree of integration may be greatly improved.

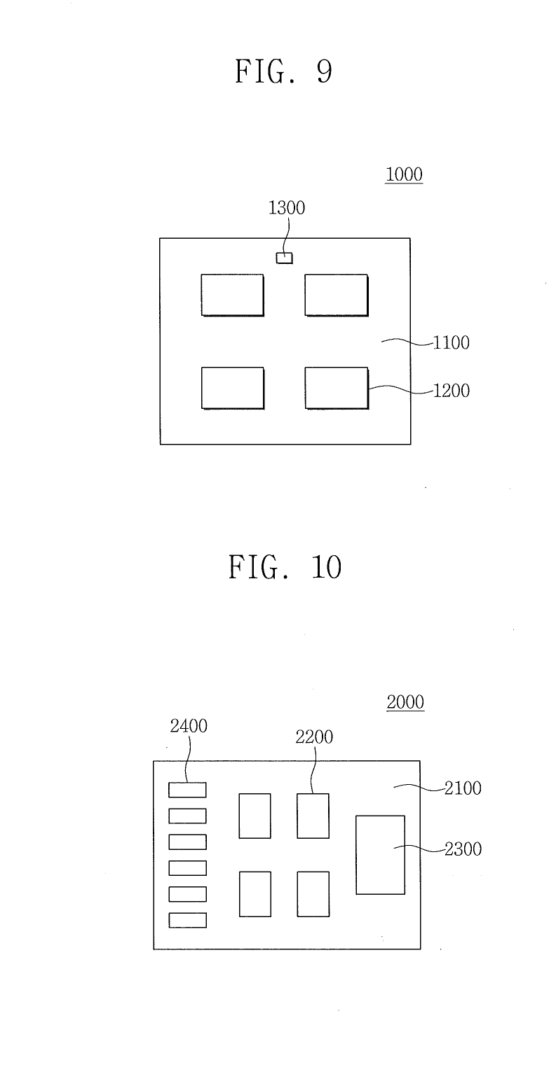

FIG. 9 is a view of construction of a memory device including an optical switching device in accordance with some embodiments of the inventive concept.

Referring to FIG. 9, a memory device 1000 including the optical switching device in accordance with some embodiments of the inventive concept may include a memory substrate 1100, a plurality of memory cells 1200, and an input/output module 1300. The memory substrate 1100 may be a bulk silicon wafer.

The plurality of memory cells 1200 may be dynamic random access memory (DRAM), static random access memory (SRAM), flash memory, phase change memory, magnetic random access memory (MRAM), and/or resistive random access memory (RRAM).

The input/output module 1300 may include the optical switching device in accordance with some embodiments of the inventive concept. For example, the input/output module 1300 may include a waveguide buried in the memory substrate 1100, an optical switching device, and/or an optical input/output device including a coupler and a photoelectric converter. Thus, the input/output module 1300 may have excellent reliability compared to the related art.

The memory device 1000 may optically receive/transmit data from/to an adjacent electronic device or another memory device 1000 using the input/output module 1300 including the optical switching device in accordance with some embodiments of the inventive concept. Thus, the memory device 1000 may receive/transmit data stably and quickly.

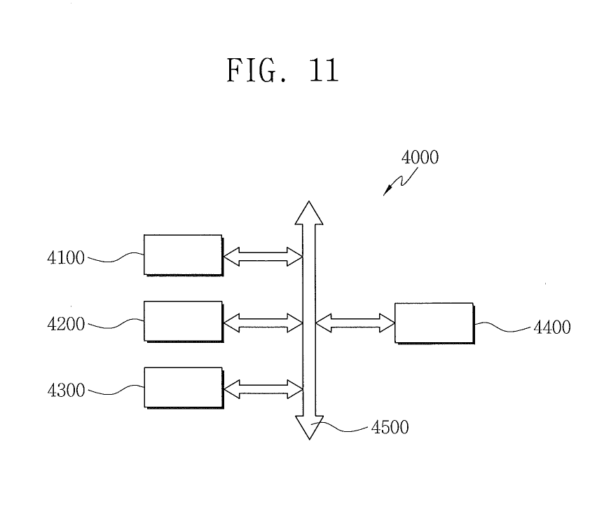

FIG. 10 is a view of construction of a semiconductor module including an optical switching device in accordance with some embodiments of the inventive concept.

Referring to FIG. 10, a semiconductor module 2000 including the optical switching device in accordance with some embodiments of the inventive concept may include a module substrate 2100, a plurality of semiconductor packages 2200, a control chip package 2300, and a plurality of input/output modules 2400. The plurality of semiconductor packages 2200 and the control chip package 2300 may be electrically connected to the plurality of input/output modules 2400.

The plurality of semiconductor packages 2200 may include volatile memory chips, non-volatile memory chips, or a combination thereof. The volatile memory chips may include DRAM and/or SRAM. The non-volatile memory chips may include flash memory, phase change memory, MRAM, and/or RRAM. The semiconductor module 2000 may not include the control chip package 2300. Thus, the semiconductor module 2000 including the optical switching device in accordance with some embodiments of the inventive concept may be a memory module. For example, the semiconductor module 2000 may be a memory card.

The plurality of input/output modules 2400 may include the optical switching device in accordance with some embodiments of the inventive concept. For example, the plurality of input/output modules 2400 may include a waveguide buried in the module substrate 2100, an optical switching device, and/or an optical input/output device including a coupler and a photoelectric converter. Thus, the plurality of input/output modules 2400 may have excellent reliability compared to the related art.

The semiconductor module 2000 may optically receive/transmit data from/to an external electronic device using the plurality of input/output modules 2400 including the optical switching device in accordance with some embodiments of the inventive concept. Thus, the semiconductor module 2000 may receive/transmit data stably and quickly.

Each of the plurality of semiconductor packages 2200 may include a memory device. That is, the plurality of semiconductor packages 2200 may include the optical switching device in accordance with some embodiments of the inventive concept. Thus, the plurality of semiconductor packages 2200 may be optically connected to each other. That is, the semiconductor module 2000 may cause data to be stably and quickly received/transmitted between the plurality of semiconductor packages 2200.

FIG. 11 is a view of construction of an electronic device including an optical switching device in accordance with some embodiments of the inventive concept.

Referring to FIG. 11, an electronic device 4000 including the optical switching device in accordance with some embodiments of the inventive concept may include an interface 4100, a controller 4200, a memory 4300, and an external input/output device 4400. The interface 4100 may be electrically connected to the controller 4200, the memory 4300, and the external input/output device 4400 via a bus 4500.

The electronic device 4000 may be a personal digital assistant (PDA), a portable computer, a web tablet, a wireless phone, a mobile phone, and/or a digital music player.

The interface 4100 may communicate data with an external system. That is, the interface 4100 may transmit/receive data to/from a communication network. The interface 4100 may include an optical input/output device in accordance with some embodiments of the inventive concept. The interface 4100 may communicate data with the external system using an optical signal. Thus, the interface 4100 may have excellent reliability compared to the related art.

The controller 4200 may include a microprocessor, a digital processor, a microcontroller, or other similar processor devices. The external input/output device 4400 may be a keypad, a keyboard, or a display.

The memory 4300 may be used to store a command executed by the controller 4200. The memory 4300 may be optically connected to the interface 4100. In this case, the memory 4300 may be a memory device including the optical switching device in accordance with some embodiments of the inventive concept. For example, the memory 4300 may include a waveguide buried in a memory substrate (not shown), an optical switching device, and/or an optical input/output device in which a coupler and a photoelectric converter are buried. Thus, data communication between the memory 4300 and the interface 4100 may show excellent reliability compared to the related art.

The electronic device 4000 may optically receive/transmit data from/to the external system using the interface 4100 including the optical switching device in accordance with some embodiments of the inventive concept. Thus, the electronic device 4000 may receive/transmit data stably and quickly.

As described above, in an optical switching device and a method of fabricating the same according to various embodiments of the inventive concept, a phase transition pattern is formed within or on an optical waveguide so as to turn on/off (i.e., allow or prevent passage of) light depending on the amount of a carrier injected therein so that high-speed/low power consumption/miniaturization of the optical switching device may be achieved and a degree of integration may be improved.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

1. An optical switching device comprising:
a substrate comprising a trench therein;
a lower cladding layer comprising an insulating material in the trench;
an optical waveguide on the lower cladding layer;
a phase transition pattern buried within a part of the optical waveguide and having a same thickness as a thickness of the optical waveguide;
first and second slabs at sides of the phase transition pattern and electrically connected to the phase transition pattern; and
an upper cladding layer on the substrate and the lower cladding layer and on the optical waveguide, the phase transition pattern, and the first and second slabs.

2. The optical switching device according to claim 1, wherein the phase transition pattern comprises a vanadium oxide.

3. The optical switching device according to claim 1, wherein each of the first and second slabs comprises silicon doped with an N-type or P-type impurity.

4. The optical switching device according to claim 3, wherein each of the first and second slabs has a respective thickness that is less than a thickness of the phase transition pattern.

5. The optical switching device according to claim 4, wherein the first and second slabs are coplanar.

6. The optical switching device according to claim 4, wherein the first and second slabs are non-coplanar.

7. The optical switching device according to claim 1, wherein the upper cladding layer comprises a same material as the lower cladding layer.

8. The optical switching device according to claim 1, further comprising:
first and second slab via plugs contacting the first and second slabs, respectively, by vertically penetrating the upper cladding layer; and
first and second slab pads on the upper cladding layer contacting the first and second slab via plugs, respectively.

9. An optical switching device comprising:
a substrate comprising a trench therein;
a lower cladding layer comprising an insulating material in the trench;
an optical waveguide on the lower cladding layer;
a lower electrode region in a part of the optical waveguide and having a same thickness as a thickness of the optical waveguide;
first and second slabs at sides of the lower electrode region and having respective thicknesses that are less than a thickness of the lower electrode region;
a phase transition pattern on the lower electrode region and parts of the first and second slabs;
an upper electrode on a part of the phase transition pattern; and
an upper cladding layer on the substrate and the lower cladding layer and on the optical waveguide, the first and second slabs, the phase transition pattern, and the upper electrode.

10. The optical switching device according to claim 9, wherein the lower electrode region and each of the first and second slabs comprise a same material.

11. The optical switching device according to claim 10, wherein the lower electrode region and each of the first and second slabs comprise silicon doped with an N-type or P-type impurity.

12. The optical switching device according to claim 9, further comprising:
a slab via plug contacting either of the first and second slabs by vertically penetrating the upper cladding layer;
an upper electrode via plug contacting the upper electrode by vertically penetrating the upper cladding layer;
a slab pad on the upper cladding layer and contacting an upper part of the slab via plug; and
an upper electrode pad on the upper cladding layer and contacting an upper part of the upper electrode via plug.

13. The optical switching device according to claim 9, wherein the upper electrode comprises:
a first upper electrode on parts of a top and side surfaces of the phase transition pattern; and
a second upper electrode spaced apart from the first upper electrode by a gap and on other parts of the top and side surfaces of the phase transition pattern.

14. The optical switching device according to claim 13, further comprising:
first and second upper electrode via plugs contacting the first and second upper electrodes by vertically penetrating the upper cladding layer; and
first and second upper electrode pads on the upper cladding layer and contacting upper parts of the first and second upper electrode via plugs.

15. The optical switching device according to claim 14, further comprising an intermediate cladding layer on the substrate and the lower cladding layer, surrounding a part of sides of the optical waveguide, and positioned between the lower cladding layer and the upper cladding layer.

16.-30. (canceled)

31. An optical switching device, comprising:
a substrate including an optical waveguide thereon;
a phase transition pattern in or on a portion of the optical waveguide, the phase transition pattern comprising a material configured to be switched between insulating and conductive states responsive to a stimulus; and
at least one conductive element on the substrate and directly contacting the phase transition pattern, wherein the at least one conductive element is configured to provide the stimulus to the phase transition pattern.

32. The optical switching device of claim 31, wherein the at least one conductive element is confined outside of the optical waveguide and extends at least partially along a sidewall thereof.

33. The optical switching device of claim 32, wherein the at least one conductive element comprises first and second slabs adjacent respective sidewalls of the optical waveguide, the first and second slabs comprising a same material as the optical waveguide and having respective thicknesses less than those of the optical waveguide and/or the phase transition pattern.

34. The optical switching device of claim 33, further comprising:
a conductive lower electrode extending within the optical waveguide between the phase transition pattern and the substrate; and
a conductive upper electrode on the phase transition pattern opposite the lower electrode,
wherein the conductive lower electrode and the first and second slabs comprise silicon doped with an n-type or p-type impurity.

35. The optical switching device of claim 33, wherein the phase transition pattern is confined within the optical waveguide.
